(19) United States
(12) Patent Application Publication
(10) Pub. No.: US 2016/0027062 A1
(43) Pub. Date: Jan. 28, 2016

(54) METHOD OF AND SYSTEM FOR PROVIDING A CLIENT DEVICE WITH PARTICULARIZED INFORMATION WITHOUT EMPLOYING UNIQUE IDENTIFIERS

(71) Applicant: YANDEX EUROPE AG, Luzern (CH)

(72) Inventor: Alexey Sergeevich MAZUROV, Moscow (RU)

(21) Appl. No.: 14/776,810

(22) PCT Filed: Mar. 11, 2014
(86) PCT No.: PCT/IB14/59642

§ 371 Date: Sep. 15, 2015

(30) Foreign Application Priority Data
Mar. 15, 2013 (RU) PCT/RU2013/000239

(51) Int. Cl. G06Q 30/02

(52) U.S. Cl. CPC G06Q 30/0269; G06Q 30/0256; G06Q 30/0277

(57) ABSTRACT

Method of providing a client device with particularized information in respect of a group of persons to which a user of the client device belongs, without employing a unique identifier with respect to the user or the client device, comprising: receiving by at least one server from the client device a request for first information from at least one network resource; receiving by the at least one server from the client device a user profile in respect of the user of the client device, the user profile including no unique identifier with respect to the user or the client device; and sending by the at least one server to the client device second information particularized in respect of the group of persons to which the user of the client device belongs, the second information being based at least in part on the user profile.

### CROSS-REFERENCE

The present application claims convention priority to International Patent Application No. PCT/RU2013/000239, filed Mar. 15, 2013, entitled “A METHOD OF AND SYSTEM FOR PROVIDING A CLIENT DEVICE WITH PARTICULARIZED INFORMATION WITHOUT EMPLOYING UNIQUE IDENTIFIERS” which is incorporated by reference herein in its entirety.

### FIELD OF THE INVENTION

The present invention relates to methods of, and systems for, providing client devices with particularized information without employing unique identifiers in respect of either the user or the client device.

### BACKGROUND

Conventional Internet-based advertisement systems (being systems for providing client devices with particularized information) of various kinds are known. Typically, in one example of such conventional advertising systems, when a computer user navigates with their browser to one of the websites that is a part of the system, the user's computer is queried to determine whether a cookie having a user identifier (ID) unique to the user (with respect to the system) is present on the user's computer. If no such unique user ID is present, one is created and is stored on the user's computer in a cookie associated with that browser. From then on each time that the user navigates with the browser in question to a website that is a part of that advertising system the user's unique ID is sent from their computer to the system. The system then uses this ID to track the user's actions on that website (or other internet resource (e.g. search engine) that is a part of that advertising system). Such information is stored by the system in a centralized database (accessible by the system's servers) in association with that unique ID. Thus, over time, the system can build up detailed information about the Internet history of the user in question (all associated with that unique ID) and use that information (amongst other things) to estimate the demographic profile and particular interests of that user. The system can then use that profile to provide that user with advertising information targeted (i.e. particularized) to that particular user (based on their demographics and particular interests). This is conventionally known as “behavioural targeting”. For example, if a user frequently visits websites concerned with car racing, the system may estimate that the user is interested in car racing and provide them with advertising associated with the purchase of tickets to car races occurring in their geographic location. (One such conventional system illustrating how this occurs is described in U.S. Pat. No. 7,698,422, issued Apr. 13, 2012 to Vanderhook et al., entitled “System and Method of Determining User Demographic Profiles of Anonymous Users”, which is incorporated herein by reference in its entirety in those jurisdictions allowing for incorporations-by-reference.

As an illustrative example of such a system, FIG. 1 shows a schematic of one prior art advertising system architecture 1400. As will be understood by those skilled in the art, the system of FIG. 1 is oversimplified one for ease in understanding such systems; typical conventional systems are of a much higher complexity. The system architecture 1400 in FIG. 1 comprises a first publisher web server 1414 in communication with a first publisher web server database 1416. The first publisher web server database 1416 stores (amongst other things) data related to the content (e.g. a first website) to be served by the first publisher web server 1414. The system architecture 1400 also comprises a second publisher web server 1418 in communication with a second publisher web server database 1420. The second publisher web server database 1420 stores (amongst other things) data related to the content (e.g. a second website) to be served by the second publisher web server 1418. The system architecture 1400 also comprises a third publisher web server 1422 in communication with a third publisher web server database 1424. The third publisher web server database 1424 stores (amongst other things) data related to the content (e.g. a third website) to be served by the third publisher web server 1422. The system architecture 1400 also comprises a fourth publisher web server 1426 in communication with a fourth publisher web server database 1428. The fourth publisher web server database 1428 stores (amongst other things) data related to the content (e.g. a Internet search engine) to be served by the fourth publisher web server 1426. (As was discussed above, as would be understood by one skilled in the art, although the present system architecture 1400 has been illustrated as having only four publisher web servers (1414, 1418, 1422, and 1426) for ease of understanding, a typical conventional system may have millions of publisher web servers.)

The system architecture 1400 also comprises an advertising server 1430 in communication with an advertising server database 1432. In the present system 1400, the advertising server database 1432 contains several different types of data including: (1) Data related to advertising (e.g. the content) to be served by advertising server 1430. (2) Data related to the various publisher web servers being a part of the system 1400 and the content that they serve (e.g. the type of information that the serve, the estimated typical demographic of their audience, etc.). (3) Data related to the users of the system 1400 (e.g. a history of the users' past interactions with the system 1400 and estimated demographics and interests of each user, each in association with a unique user ID (on a per user basis)). (As was discussed above, as would be understood by one skilled in the art, although the present system architecture 1400 has been illustrated as having only one advertising server 1430 and one advertising database 1432 for ease of understanding, a typical conventional system may employ many servers and/or databases and may be of a much more complex structure.)

As is also shown in FIG. 1, there are two users of the system 1400, a first user 1410 and a second user 1412. Each of the users 1410 and 1412 has a unique user identifier (ID) with respect to the system 1400. User 1 (1410) has a unique ID #001 and user 2 (1412) has a unique ID #002. (As was discussed above, as would understood by one skilled in the art, although the present architecture 1400 has been illustrated as having only two users (1410, 1412) for ease of understanding, a typical conventional system may have tens of millions of users.)

Referring now to FIG. 2, in operation the system 1400 works in the following manner (using User 1—1410 as an example and assuming User 1 has already previously interacted with system 1400): User 1 has a client device, which may, as a non-limiting example be a personal computer running the Microsoft™ Internet Explorer™ web browser on the Microsoft Windows™ operating system and being connected to the Internet. User 1 issues a request to the first publisher web server 1414 (for example) to be provided with a first published website. User 1 does this, for example, by entering into the address bar of their web browser the Internet domain name of first publisher web server 1414, which may for example be “www.pub1.com”. First publisher web server 1414 receives, via the Internet, the request from User 1's client device to be provided with the first website published via the first publisher web server 1414 (at 1010). First publisher web server 1414, being part of architecture 1400, issues a request to User 1's client device via the Internet to be provided with User 1's unique user ID in respect of architecture 1400 (at 1012). User 1's client device receives the request in respect of the unique user ID (which in this case is #001), which is stored in a cookie associated with User 1's web browser. User 1's web browser forwards the unique user ID (#001) back to the first publisher web server 1414, via the Internet, in response to the first publisher web server's 1414 request. First publisher web server 1414 receives the unique user ID from the client device (at 1014). First publisher web server 1414 then retrieves the content to be served (i.e. the first publisher web site) from the 1414 publisher web server database 1416 and servers it to the client (at 1016). First publisher web server 1414 then forwards the unique user ID in respect of User 1 to the advertising server 1430 (at 1018). Advertising server 1430 receives the unique user ID from first publisher web server 1414. Advertising server 1430 then stores an indication of the fact that User 1 has requested information from first publisher web server 1414 in the advertising database 1432. Advertising server 1430 then retrieves estimated demographic and user interest information regarding User 1 from the advertising database 1432. Advertising server 1430 then determines, using the demographic and estimated user interest information retrieved from the advertising database 1432 and other information available to the advertising server 1430 (such as the then current geographic location of User 1's client device—which the advertising server may have received via any number of conventional methods), specific particularized advertising content to be provided to User 1. (As a simplistic example for purposes of illustration, the advertising server 1430 will select advertising content related to the estimated interests, demographic profile and location of the user.) Advertising server 1430 then retrieves the particularized advertising content from the advertising database 1432 and forwards it, via the Internet, to the first publisher web server 1414 (at 1018). First publisher web server 1414 then receives the particularized advertising content from the advertising server 1414 (at 1020) and forwards it to the User's client device (at 1022). The User's client device receives both the published content (e.g. the web page) and the particularized advertising content, and the web browser displays both types of content together in a coherent manner (as they are intended to be displayed by the designer of the first publisher web site).

As was discussed in the previous paragraph, the advertising server 1430 stores an indication of the fact that User 1 has requested information from the first publisher web server 1414. (In most conventional systems of this type, as would be understood by those skilled in the art, in actuality a greater amount of detail with respect to User 1's interaction with respect to the first website is stored in the advertising database 1432.) However, the user's request for information regarding the first website from the first publisher web server 1410 is not the only type of information that is stored in the advertising database. Referring to FIG. 3, another non-limiting example is shown and is described hereinafter (although in less detail than the previous example solely for ease in understanding). In FIG. 3, the advertising server 1430 receives from a publisher web server (e.g. first publisher web server 1414) (via the Internet) a unique user ID in respect of a user (e.g. User 1—1410) interacting with the publisher web server (at 1110). The advertising server 1430 updates the advertising database 1432 with information in respect of the user's interaction with the publisher web server (at 1112). The information in respect of the user is associated with that user's unique user ID (e.g. #001) in the advertising database 1432. The advertising server 1430 determines which particularized advertising content will be provided (ultimately, whether directly or indirectly) to the user by using (amongst other things) the information stored in the advertising database 1432 in respect of that user. As was discussed above, such information will likely include demographic and user interest information in respect of the user and may include other information as well. The advertising server 1430 selects particularized advertising information that is more likely to be in respect of products and/or services that the user is likely be interested (such information may be termed “information targeted at the user”) based on the information available. The advertising server 1430 serves the particularized advertising content to the publisher web server (at 1116), which serves the information to the user's client device. Should the user “click” on the advertising content (indicating that the user desires further information about the products and/or services being advertised in the advertisement that the user clicked on), an indication of this is ultimately sent to the advertising server 1430 (at 1118). The advertising server 1430 then updates the advertising server database 1432 with the information that the user clicked on the particular advertising content (at 1120). This information will be used by the advertising server 1430 in the future in the determination of which advertising content will be sent to the user (“particularizing the advertising information”). (In some conventional systems, although not shown in FIG. 3, the fact that a user did not click on particular advertising content is also sent to the advertising server 1430, stored in the advertising database 1432, and is also used in particularizing advertising information in the future.)

Referring to FIG. 4, another non-limiting example of information stored by the advertising server 1430 in the advertising database 1432 is shown and is described hereinafter (although in less detail than the previous examples solely for ease in understanding). In this example, a user interacts with a search engine (e.g. Fourth Publisher Web Server 1426) that is part of the system 1400. In this example, a user may, for example, navigate to the home page of the search engine by entering into the address bar of their web browser the domain name of the search engine (e.g. “www.search-engine.com”). The web browser will then display the search bar of the search engine in its browser window, into which the user may enter a search query (e.g. “search term 1”). The search engine will then execute a search in respect of the search query and will forward the search results to the user's client device. The user's client device will display the search results in the web browser's browser window. The user may then click on one of the search results to be provided with information located at that particular search result. (As would be understood by those skilled in the art, the aforementioned description is one of a simplistic conventional interaction of a user with a search engine that has been simplified for ease in understanding.) Further, as would also be understood by those skilled in the art, the search engine server (e.g. fourth publisher web server 1426) being a part of system architecture 1400 queries the user's client device and is provided with the user's unique user ID (with respect to the system). The advertising server 1430 receives the user's unique user ID, the user's search query, and any search results having been provided to the user by the search engine that the user has “clicked” on by the fourth publisher web server, and stores this information in the advertising database 1432. This information thus becomes a part of the information that will then be used by the advertising server in particularizing the advertising content to be provided to that user in the future.

In the previous examples the user (e.g. User 1—1410) had previously interacted with system 1400 and thus a unique user ID with respect to the system was stored on the user's client device (e.g. in a cookie). Referring to FIG. 5, there is a shown a conventional procedure related to the assignation of a user ID to a new user who has never previously interacted with the system 1400 (e.g. User 2—1412), whether via that particular client device or otherwise. The process shown in FIG. 5 is generally similar to that shown in FIG. 1 and therefore common details are omitted for ease of understanding. In the process of FIG. 5, a Publisher web server (e.g. Second Publisher Web server 1418) receives a request from a user's client device for content (e.g. second publisher web site), via the Internet (at 1310). The publisher web server (being a part of a system 1400) queries the user's client device for a unique user ID (with respect to the system) (at 1312). However, since the user has never previously interacted with the system, a nil response is received by the publisher web server from the client device (at 1314). Having received a nil response, the publisher web server requests a unique user ID in respect of the user from the advertising server 1430 (at 1316). The advertising server 1430 assigns a unique user ID (e.g. #002) in respect of the user and stores that unique user ID in the advertising database 1432. The assigned unique user ID is forwarded by the advertising server 1430 to the publisher web server and is received thereby (at 1318). Publisher web server then forwards the unique user ID to the client device (at 1320) where it is stored in a cookie associated with the web browser that the user is currently using (to access the content on second publisher web server).

Such conventional advertising systems are examples of systems that provide users of client devices with information (in this case the advertising information) that is particularized to them. However such systems of providing users of client devices with particularized information are not limited to advertising systems, they may be used to provide various kinds of particularized information to a user based upon the information that they have collected about the user.

A concern with respect to conventional advertising systems, such those described above, is user privacy. While users may generally (and often do) appreciate receiving advertising targeted directly at them (as opposed to general advertising), they may not wish their actions to be tracked in the manner described, and stored on in a centralized Internet-accessible database. This is particularly the case where there is no way for a user to delete the information stored about them in such a system. (In a system such as the one described above, the user can delete the cookie on their computer containing their unique user ID, but that does not delete the information stored about them in the system's centralized databases.) Further, even if a system in question were to allegedly provide a way to delete a user's information from its databases, there would be no means for a user to verify that this has been done. However, since current conventional advertising systems all require user modeling and behavioural targeting as described above (which require unique user IDs) in order to function and provide the users with the benefits of such systems, these concerns cannot be addressed by such systems.

### SUMMARY

It is therefore an object of the present technology to ameliorate at least one of the inconveniences present in the prior art, be it one of those described above or otherwise.

It is therefore a further object of the present technology to provide a system (e.g. an advertising system) that is capable of providing users of client devices with particularized information targeted to them while not using any identifier specific to the user or to the user's device to do so. Thus, while depending on how the present technology is specifically implemented in any given specific implementation, the present technology allows for the design of systems similar to those described above such that users of such could continue to receive at least some of the benefits described above, while at least some of their privacy concerns could nonetheless be addressed.

The present technology results from a reconceptualization of the provision of particularized information to users of client devices. Rather than attempt to define the particular demographics and interests of each individual user (and store those particular demographics and interests in a centralized Internet-accessible database with a unique user ID), the present technology attributes demographic information and user interests to specific groups of users and then places users in a particular group. Particularized content may then be provided in respect of each specific group, and thus to users being members of each specific group (or said another way—users belonging to each specific group). The group of which a user is member can be stored on the user's client device and provided to the system when the provision of particularized information is required. Thus, for any particular user, as long as an indication of the group of which that particular user is a member is provided (directly or indirectly) to a content server, that particular user can be provided with particularized content directed at the specific group of which that particular user is a member. Therefore via the present technology, a user can receive particularized information without the system utilizing unique user IDs and/or centrally tracking a user's Internet usage history (as was described above).

Thus, in one aspect, some implementations of the present technology provide a method of providing a client device with particularized information in respect of a group of persons to which a user of the client device belongs, without employing a unique identifier with respect to the user or the client device, the method comprising:
receiving by at least one server from the client device via a communications network a request for first information from at least one network resource;
receiving by the at least one server from the client device via the communications network a user profile in respect of the user of the client device, the user profile including no unique identifier with respect to the user or the client device; and
sending by the at least one server to the client device via the communications network second information particularized in respect of the group of persons to which the user of the client device belongs, the second information being based at least in part on the user profile.

In another aspect, some implementations of the present technology provide a computer system for providing a client device with particularized information in respect of a group of persons to which a user of the client device belongs, without employing a unique identifier with respect to the user or the client device, the system comprising:
a request for first information reception component for effecting reception by at least one server from the client device via a communications network of a request for first information from at least one network resource;
a user profile reception component for effecting reception by the at least one server from the client device via the communications network of a user profile in respect of the user of the client device, the user profile including no unique identifier with respect to the user or the client device; and
a second information dispatch component that effects dispatch by the at least one server to the client device via the communications network of second information particularized in respect of the group of persons to which the user of the client device belongs, the second information being based at least in part on the user profile.

In another aspect, some implementations of the present technology provide a computer usable information storage medium having computer readable program code embodied thereon for providing a client device with particularized information in respect of a group of persons to which a user of the client device belongs, without employing a unique identifier with respect to the user or the client device, the computer readable program code including instructions that when executed by a computer effect:
reception by at least one server from the client device via a communications network of a request for first information from at least one network resource;
reception by the at least one server from the client device via the communications network of a user profile in respect of the user of the client device, the user profile including no unique user identification with respect to the user or the client device;
dispatch by the at least one server to the client device via the communications network of second information particularized in respect of the group of persons to which the user of the client device belongs, the second information being based at least in part on the profile.

The present technology differs from conventional technology in that no unique identifier of either the user or of a client device is used in order to provide a user of a client device with particularized information. (In the context of the present specification the “user” of a client device should be understood to be the person who is the only person who uses the client device or who is the person who uses the client device most of the time the client device is used.)

At a very high level, in the present technology, a user profile is stored on a client device. When the client device interacts with a server (or servers) employing the present technology in respect of an Internet resource to retrieve information from that Internet resource, a user profile is sent by the client device to the server(s). The server(s) may then provide (or cause the provision to) the client device with particularized information based on the received user profile.

The user profile does not contain any unique identifier of either the user or of the client device. Rather the user profile contains information either related to a group being one of a series of predetermined groups (with respect to the system) to which the user belongs (or alternatively the user profile may contain information enabling such a group to be determined). In general such groups are likely to be related to demographic and interest information of the user, but this is not required to be the case. The server(s) thus sends to the client device particularized information in respect of that group (and not the individual). The more groups that have been defined in any particular implementation, the more particularized the information may be to any specific group, and thus to a user of a client device being a member of that specific group. At an extreme, a very large number of groups may be defined, such that relatively very particularized information may be provided to users being a member of any particular group.

As a result of being structured in this manner, however, the server(s) are not provided with information uniquely identifying any particular user or client device. They are only provided with “grouping” information. Thus, at any particular point in time the server(s) are not “aware” of whom a particular user is, only the group of which that user is a member. So no tracking of any unique user or client device occurs or can be recorded in centralized databases with which the server(s) are in communication (in association with unique user IDs). Only information related to the group of which a particular user is a member may be so recorded.

As a further result of the present technology being structured in this manner, assuming the client device were configured to permit it, the user profile could be deleted from the client device. In such a case, the next time that the client device were to enter into communication with a server employing the present technology, the server would “view” the client device as new and would begin the profile creation/adaption process afresh.

As a further result of the present technology being structured in this manner, assuming the client device were so configured, the client device could prevent the creation of such a user profile (effectively preventing the server(s) from providing the client device with particularized information) or the client device could prevent the modification of a such a user provide (effectively “freezing the user profile in time” preventing any further change in the particularization of the information being provided to the client device).

As was discussed above, the groups may be defined in any fashion suitable for the overall purposes for which the particularized information is being provided. It is likely (although not required) that in most implementations, some demographic and user interest information will be used with respect to the definition of the groups. For example, groups may be defined with respect various combinations of age, gender, family situation, location, employment type, income level, estimated interests (e.g. sports, news, fashion, etc.), etc. No particular group definition strategy or structure is required in respect of the present technology.

No particular means of initial creation of the user profile is required in respect of present technology. Thus, as a non-limiting example, the present technology could be implemented such that when a client device interacts with a server employing the present technology for the first time (either because the client device has never previously interacted with such server(s) or because the user profile has been deleted from the client device), the server(s) may send (or cause to be sent) to the client device an initial user profile. Such initial user profile could, for example, be a generic user profile sent to all “first-time” users, or it could be one of a number of more specific initial profiles that are sent to “first-time” users based on some initial information (e.g. the particular Internet resource that the first-time user is interacting with when they are first encountered). As another non-limiting example, the present technology could be implemented in such a way that no initial user profile is ever sent to a client device automatically, rather the user of the client device must take some action in order to cause such a profile to be created. For example, the user of the device could, via an application (be it a web application or a local application), cause the creation of an initial user profile on the client device. In such an example, the user could be given the choice as to select the initial group to which they belong, or the choice to influence a user profile to be selected by the system.

Similarly, no particular means of modification of a user profile is required in respect of the present technology. While it is likely that in most implementations, the user profile will be dynamically modified over time as the user interacts with servers employing the present technology, this is not required to be the case. As a non-limiting example, for instance, the user profile could contain a flag that indicates that the user profile is to remain static unless changed by the user. In such cases the system would not dynamically modify the user profile. In might be the case that at any time the user so desires, the user could change the user profile (including the static/dynamically modify setting (were one to exist)) via, for example, an application (be it a web application or a local application), whether or not the user profile at that time were being dynamically modified or were static.

The present technology does not require that the particularization of the particularized information to be sent to the user be based solely on the user profile. The particularized information could also be based in part on other information available to the server(s) employing the present technology. For example, were the groups of the system to be defined such that the location of the user were not taken into account, the system could nonetheless, via, for example, the IP address of the user, take such information into account when determining which particularized information to provide to the user.

Aside not containing any unique identifier of either the user or of the client device, the present technology does not have any particular requirements with respect to the structure or content of the user profile. The particular structure and/or content of a user profile of the present technology may vary among various implementations of the present technology.

The present technology does not require (although it does not prohibit) that the user profile be stored with any additional information. By way of non-limiting example, a user profile of the present technology may be stored on a client device along with some or all of the previous requests for information from Internet resources of the user (since the creation of the user profile), whether those requests affected the grouping of the user or not.

In the context of the present specification, a “server” is a computer program that is running on appropriate hardware and is capable of receiving requests (from client devices) over a network, and carrying out those requests, or causing those requests to be carried out. The hardware may be one physical computer or one physical computer system, but neither is required to be the case with respect to the present technology. In the present context, the use of the expression “at least one server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “a client device” is any computer hardware that is capable of running software appropriate to the relevant task at hand. Thus, some (non-limiting) examples of client devices include personal computers (desktops, laptops, netbooks, etc.), smartphones, and tablets.

In the context of the present specification, a “database” is any structured collection of data, irrespective its particular structure, database management software, or computer hardware on which the data is stored, implemented or otherwise rendered available for use. A database is in “operational communication” in the present context when it is rendered available for use as part of a database management system that is itself connected to an accessible communications network.

In the context of the present specification, the expression “information” includes information of any nature or kind whatsoever capable of being stored in a database. Thus information includes, but is not limited to audiovisual works (pictures, movies, sound records, etc.) location data, text (opinions, comments, questions, messages, etc.), etc.

In the context of the present specification, the expression “component” is meant include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation.

In some implementations, the above method further comprises:
categorizing the first information by the at least one server;
updating the user profile by the at least one server to take into account the categorized first information to create an updated user profile; and
sending by the at least one server to the client device via the communications network the updated user profile.

In some implementations of the above computer system, the computer system further comprises:
a categorization component that effects categorization of the first information by the at least one server;
a user profile update component that effects an update of the user profile by the at least one server to take into account the categorized first information to create an updated user profile; and
an updated user profile dispatch component that effects dispatch by the at least one server to the client device via the communications network of the updated user profile.

In some implementations of the above computer usable information storage medium, the computer readable program code further includes instructions that when executed by the computer effect:
categorization of the first information by the at least one server;
an update of the user profile by the at least one server to take into account the categorized first information to create an updated user profile; and
dispatch by the at least one server to the client device via the communications network of the updated user profile.

Thus, the information requested by a user with respect to an Internet resource may be categorized and used to create an updated user profile.

As a non-limiting example, were a user to request information from the website “www.nascar.com”, the server(s) might categorize that request for information as “sports”, “car racing”, “U.S.-related”, “U.S.-located”, “male”, “ages 18-55”, etc. (“Categorize” in the present context should be understood as determining to which category or categories (in respect of the present technology) that a particular request for information belongs to, irrespective of whether those categories had been predetermined (e.g. previously assigned to a particular Internet resource or content thereof) or whether new categories must be created.) That categorization may then be used to update the user profile. Thus, were, for example, the groups to have been defined to include an estimated age of the user (a “classification” as is discussed in further detail below), assuming that until the request for information in respect of the NASCAR™ website had been received the group into which the user had been placed was with respect to “age-not-yet-estimated”, after the receipt of that request the user profile might be updated to place the user into a group in respect of “persons estimated to have an age of between 18 and 55”.

As is evident from the foregoing example, it should be understood that one or multiple categories may be assigned to an Internet resource (or particular content thereof), and that the categories assigned may or may not be related to one another in some way. Further, the assignment of categories to an Internet resource need not be static, it may (although it need not) change over time. The assignment of categories to Internet resources may be automated (e.g. computer-implemented), it may be manual (e.g. effected by humans), or it may be some combination of the two. The present technology requires no particular scheme or structure of categories, nor manner of the assignment thereof to Internet resources.

It is not required (nor it is prohibited) that the user profile be updated after each and every request for information from an Internet resource. By way of non-limiting example, the user profile may only be updated after a request from information from certain Internet resources (how ever those certain Internet resources may be defined). In should be evident that the user profile may need not to be updated after any particular information from an Internet resource. This may be the case for example, as the categorization of that Internet resource does not require it because the user profile is already in line with that categorization. (Building on the previous example, for example, were a user having requested information from the NASCAR website already to have been grouped into a group in respect of person having an age of between 18 and 55 (amongst other things), then the user's profile would not need to be updated in view of the request for information from the NASCAR website, given that website's above-noted categorization. (It should be understood that this example has been purposefully been made very simple for purposes of easing understanding of this point.) In other examples, the user profile may not need to be updated, for instance, where a particular request for information is anomalous (given, for example, the user's previous Internet usage history). This might be the case, for example, where the user has been placed into a group in respect of persons 85 or older (amongst other things) in view of their Internet usage history, but requests information from the NASCAR website. The server(s) may determine that request to be anomalous (as there are some 85-year-old persons who may be interested in NASCAR, or as the client device in question may at that particular point in time be being used by a person other than its user) and not update the user profile.

In such implementations updated user profiles are sent to the client device by the server(s) and in most implementations will automatically replace the then current user profile in terms of the user profile that will, from that time forward until another updated user profile is received, be sent by the client device. Automatic updating, is however, not required by the present technology, and implementations where automatic updating does not occur are within the scope of the present technology. Further, non-current user profiles may be retained on the client device or may be automatically deleted; neither is required by the present technology.

In some implementations of the above method, the method further comprises receiving by the at least one server from the client device via the communications network additional information respecting actions of the user with respect to at least one of the at least one network resource and an additional network resource, the additional information including no unique identifier with respect to the user or the client device; and the second information is based at least in part on the additional information.

In some implementations of the above computer system, the computer system further comprises an additional information reception component that effects reception by the at least one server from the client device via the communications network of additional information respecting actions of the user with respect to at least one of the at least one network resource and an additional network resource, the additional information including no unique identifier with respect to the user or the client device; and the second information is based at least in part on the additional information.

In some implementations of the above computer usable information storage medium, the computer readable program code further includes instructions that when executed by the computer effect receipt by the at least one server from the client device via the communications network additional information respecting actions of the user with respect to at least one of the at least one network resource and an additional network resource, the additional information including no unique identifier with respect to the user or the client device; and wherein the second information is based at least in part on the additional information.

Thus, for example, the second information may be (or may further be) particularized in respect of the user's actions with respect to the information received from the first network resource or from an additional network resource. In a non-limiting example, such an additional network resource might be a generic (i.e. non-particularized) advertisement having been sent to the client device along with the first information.

In another aspect, some implementations of the present technology provide a method of providing a client device with particularized information in respect of a group of persons to which a user of the client device belongs, without employing a unique identifier with respect to the user or the client device, the method comprising:
sending by the client device to at least one server via a communications network a request for first information from at least one network resource;
sending by the client device to the at least one server via the communications network a user profile in respect of the user of the client device, the user profile including no unique user identification with respect to the user or the client device;
receiving by the client device from the at least one server via the communications network the first information;
receiving by the client device from the at least one server via the communications network second information particularized in respect of the group of persons to which the user of the client device belongs, the second information being based at least in part on the profile.

In another aspect certain implementations of the present technology provide a computer system for providing a client device with particularized information in respect of a group of persons to which a user of the client device belongs, without employing a unique identifier with respect to the user or the client device, the system comprising:
a request for first information dispatch component that effects dispatch by the client device to at least one server via a communications network of a request for first information from at least one network resource;
a user profile dispatch component that effects dispatch by the client device to the at least one server via the communications network of a user profile in respect of the user of the client device, the user profile including no unique identifier with respect to the user or the client device;
a first information reception component that effects reception by the client device from the at least one server via the communications network of the first information; and
a second information reception component that effects reception by the client device from the at least one server via the communications network of second information particularized in respect of the group of persons to which the user of the client device belongs, the second information being based at least in part on the user profile.

In another aspect, some implementations of the present technology provide a computer usable information storage medium having computer readable program code embodied thereon for providing a client device with particularized information in respect of a group of persons to which a user of the client device belongs, without employing a unique user identification with respect to the user or the client device, the computer readable program code including instructions that when executed by a computer effect:
dispatch by the client device to at least one server via a communications network of a request for first information from at least one network resource;
dispatch by the client device to the at least one server via the communications network of a user profile in respect of the user of the client device, the user profile including no unique identifier with respect to the user or the client device;
reception by the client device from the at least one server via the communications network of the first information; and
reception by the client device from the at least one server via the communications network of second information particularized in respect of the group of persons to which the user of the client device belongs, the second information being based at least in part on the profile.

In some implementations, the above method further comprises receiving by the client device from the at least one server via the communications network an updated user profile, the updated user profile taking into account a category of the first information.

In some implementations of the aforementioned computer system, the computer system further comprises an updated user profile reception component that effects reception by the client device from the at least one server via the communications network of an updated user profile, the updated user profile taking into account a category of the first information.

In some implementations of the above computer usable information storage medium, the computer readable program code further includes instructions that when executed by the computer effect reception by the client device from the at least one server via the communications network of an updated user profile, the updated user profile taking into account a category of the first information.

In some implementations, the above method further comprises:
categorizing the first information by the client device; and
updating the user profile by the client device to take into account the categorized first information to create an updated user profile.

In some implementations of the aforementioned computer system, the computer system further comprises:
a categorization component that effects categorization of the first information by the client device; and
a user profile update component that effects an update of the user profile by the client device to take into account the categorized first information to create an updated user profile.

In some implementations of the above computer usable information storage medium, the computer readable program code further includes instructions that when executed by the computer effect:
categorization of the first information by the client device; and
an update of the user profile by the client device to take into account the categorized first information to create an updated user profile.

Thus, in contrast to some of the implementations described earlier, in other implementations the categorization of the request for information and the updating of the user profile takes place on the client device (as opposed to via a server(s) with which the client device is in communication).

In some implementations, the above method further comprises receiving by the client device from the at least one server via the communications network a collection of categories to be used in categorization of the first information.

In some implementations, the above computer system further comprises a category reception component that effects reception by the client device from the at least one server via the communications network of a collection of categories to be used in categorization of the first information.

In some implementations of the above computer usable information storage medium, the computer readable program code further includes instructions that when executed by the computer effect reception by the client device from the at least one server via the communications network of a collection of categories to be used in categorization of the first information.

In some implementations, the above method further comprises sending by the client device to the at least one server via the communications network additional information respecting actions of the user with respect to at least one of the at least one network resource and an additional network resource, the additional information including no unique identifier with respect to the user or the client device; and the second information is based at least in part on the additional information.

In some implementations of the aforementioned computer system, the computer system further comprises an addition information dispatch component that effects dispatch by the client device to the at least one server via the communications network of additional information respecting actions of the user with respect to at least one of the at least one network resource and an additional network resource, the additional information including no unique identifier with respect to the user or the client device; and wherein the second information is based at least in part on the additional information.

In some implementations of the above computer usable information storage medium, the computer readable program code further includes instructions that when executed by the computer effect dispatch by the client device to the at least one server via the communications network of additional information respecting actions of the user with respect to at least one of the at least one network resource and an additional network resource, the additional information including no unique identifier with respect to the user or the client device; and wherein the second information is based at least in part on the additional information.

In some implementations, the above method further comprises deleting the user profile from the client device thereby preventing receipt of the second information particularized in respect of the group of persons to which the user of the client device belongs until a new user profile is created.

In some implementations of the aforementioned computer system, the computer system further comprises a user profile deletion component that effects a deletion of the user profile from the client device thereby preventing receipt of the second information particularized in respect of the group of persons to which the user of the client device belongs until a new user profile is created.

In some implementations of the above computer usable information storage medium, the computer readable program code further includes instructions that when executed by the computer effect deletion of the user profile from the client device thereby preventing receipt of the second information particularized in respect of the group of persons to which the user of the client device belongs until a new user profile is created.

Thus, in some implementations, the deletion of a user profile from the client device will prevent the receipt of particularized information until a new user profile is created. This will typically be the case when the information contained in the user profile is the only information that is used to particularize the information to be sent to the client device (as opposed to using that information in combination with additional information as was described hereinabove).

In some implementations of the aforementioned methods, systems, and computer usable information storage media, the request for first information is a request to effect a search in respect of a search query and to be provided with results of the search. (E.g. the user has entered a search query in a search query entry box in an Internet web browser and has clicked the “Search” button.) In others, the request for first information is a request to navigate to an Internet website. (E.g. the user has entered a URL into the address box of an Internet web browser and has hit the Enter key on the keyboard.) In others, the request for first information is a request to be provided with additional information in respect of an advertisement having been provided to the user via a user interface of the client device. (E.g. the user has, for example, clicked on an advertisement having been presented to them.)

In some implementations of the aforementioned methods, systems, and computer usable information storage media, the user profile includes a series of classifications. The classifications are the attributes of the group of which the user is a member. By way of non-limiting example, assuming that the user is a member of a group being defined as North American, males, aged 18-35, employed, soccer, sports cars; each of “North American”, “male”, “aged 18-35”, “employed”, “soccer” and “sports cars” would be a classification.

In some such implementations, the classifications are based on estimated interests of the user. Thus, continuing with the previous example, “soccer” and “sports cars” would be classifications based on estimated interests of the user.

In some such implementations, the estimated interests of the user are based at least in part on a past usage history of the user. Thus, in such implementations, the user is put into a group whose classifications are in-line with the categories of the internet resources that they had previously requested information from (or interacted with). Thus, by way of noon-limiting example, assuming the user were to have previously requested information from internet websites having been categorized as one or more of “male”, “aged 18-35” and “North American” then they would be placed into a group having the classifications of “male”, “aged 18-35” and “North American”. (It should be understood that this example has been oversimplified for instructive purposes.)

In some such implementations, the categories are based in part on an estimated demographic profile of the user. Thus, continuing with the previous example, “male” and “aged 18-35” and “employed” would be classifications based on an estimated demographic profile of the user. The demographic profile is “estimated” as no unique identifier of the user or of the client device is used in the present technology, thus there is no way to determine for certain the demographic profile of the user (other than having the user enter it themselves and even then there is no way to know whether the user has entered the information truthfully).

In some such implementations, the estimated demographic profile of the user is based at least in part of a past usage history of the user.

In some such implementations, the user profile includes probabilities associated with the classifications. Given that there is no way to determine for certain any particular attributes of a classification in a user profile, in some implementations some or all of the classification may be accompanied by an associated probability that that classification is correct. For example, classification “male” might be accompanied by a probability of 90%. Thus there would be a 90% chance that users who are members of that particular group are male.

In some implementations of the aforementioned methods, systems, and computer usable information storage media, the user profile is encoded. By means of non-limiting example, the various groups could be assigned numbers and the user profile could contain simply the number of the group of which that user is a member (rather than a list of the classifications of the group). Thus, in a very simple example, assuming that there are 5 groups total: Group 1—Male (76%-100%), Group 2—Male (51%-75%), Group 3—Unknown, Group 4—Female (51%-75%), and Group 5—Female (76%-100%); a user profile would contain the number 1 rather than “Male (76%-100%)”. The number of the group need be expressed in the decimal system (base 10), it could, for instance, be in the binary system (base 2), or in the hexadecimal system (base 16) or any other suitable system. In some implementations encoding the user profile may reduce the amount of information needed to be sent and/or received.

In some implementations of the aforementioned methods, systems, and computer usable information storage media, the user profile is stored in a cookie on the client device. As would be understood by those skilled in the art, a “cookie” is a small piece of data stored on a computer for use in association with a user's web browser. In other implementations, the user profile is stored in a library on the client device. As would be understood by those skilled in the art, a “library” includes information organized and stored in such a way that it can be used by multiple programs that have no connection to each other. It should be understood however no particular means of storage of the user profile is required with to the present technology. Thus the present technology does not require that the user profile be stored in a cookie or a library.

In some implementations of the aforementioned methods, systems, and computer usable information storage media, the second information is advertising information. It should be understood however that the particularized information with respect to the present technology is not restricted to advertising information. Other types of particularized information (e.g. news) may be employed as well.

Embodiments of the present invention each have at least one of the above-mentioned object and/or aspects, but do not necessarily have all of them. It should be understood that some aspects of the present invention that have resulted from attempting to attain the above-mentioned object may not satisfy this object and/or may satisfy other objects not specifically recited herein.

Additional and/or alternative features, aspects and advantages of embodiments of the present invention will become apparent from the following description, the accompanying drawings and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a schematic of a computer system architecture of the prior art.

FIG. 2 is a flow chart showing a first prior art procedure for using the computer system of FIG. 1.

FIG. 3 is a flow chart showing a second prior art procedure for using the computer system of FIG. 1.

FIG. 4 is a flow chart showing a third prior art procedure for using the computer system of FIG. 1.

FIG. 5 is a flow chart showing a fourth prior art procedure for using the computer system of FIG. 1.

FIG. 6 is a schematic of a computer system architecture being an implementation of the present technology.

FIGS. 7A-C are a flow chart showing a first prior art procedure for using the computer system of FIG. 6.

FIGS. 8C-E are a flow chart showing a second prior art procedure for using the computer system of FIG. 6.

FIGS. 9A-E are a flow chart showing a third prior art procedure for using the computer system of FIG. 6.

FIGS. 10A-C are a flow chart showing a fourth prior art procedure for using the computer system of FIG. 6.

FIGS. 11A-E show example user profiles of the present technology.

FIGS. 12A-E show example cookies storing profiles of the present technology.

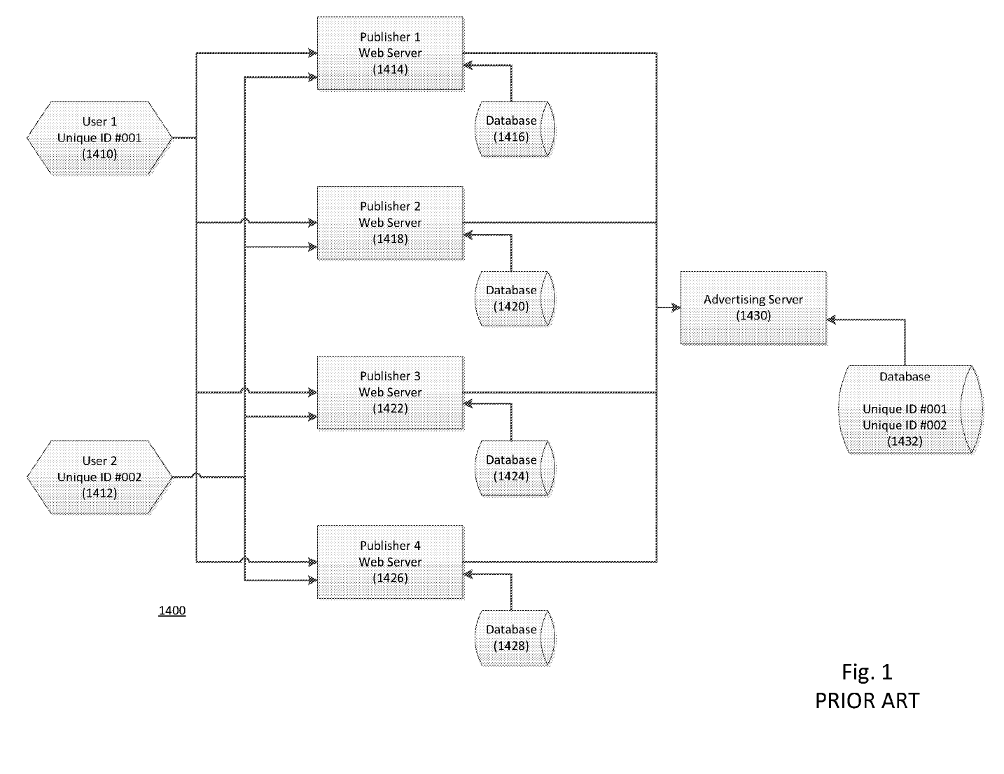

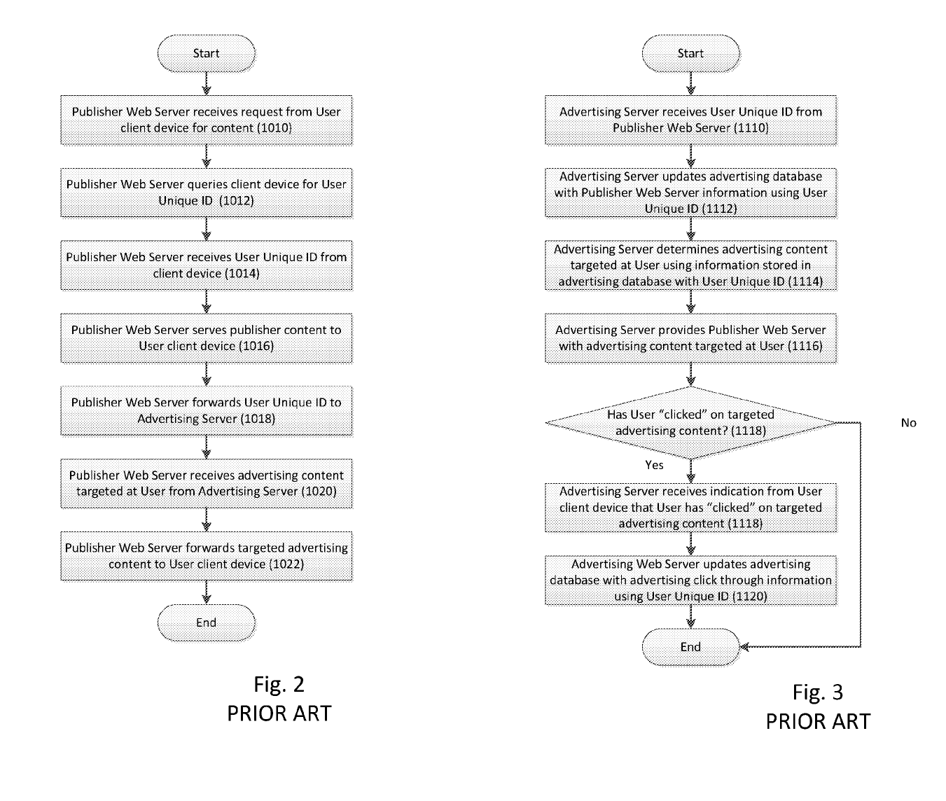

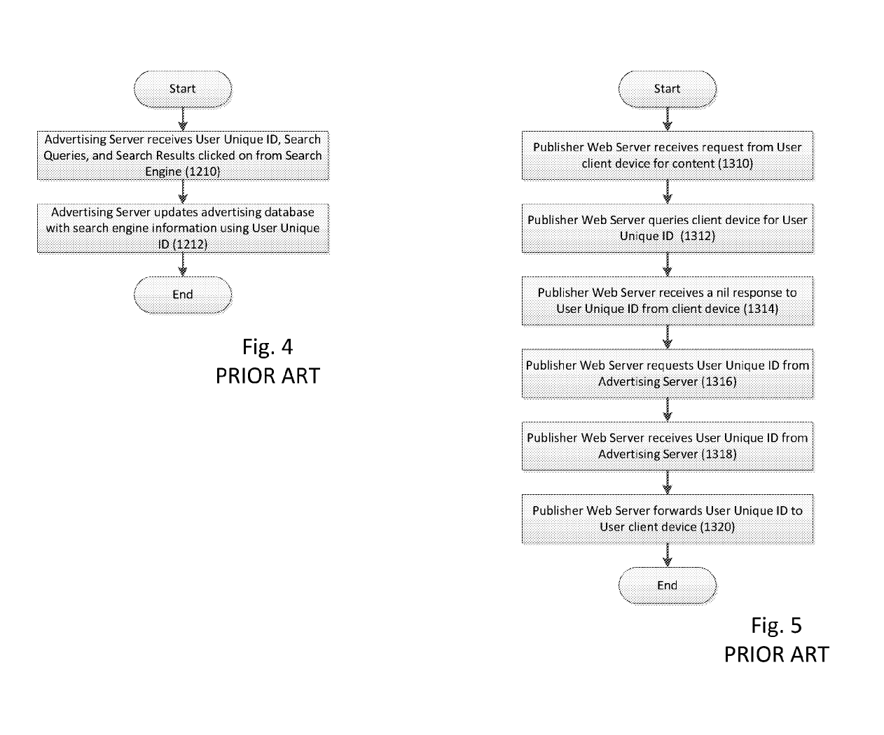

### DETAILED DESCRIPTION

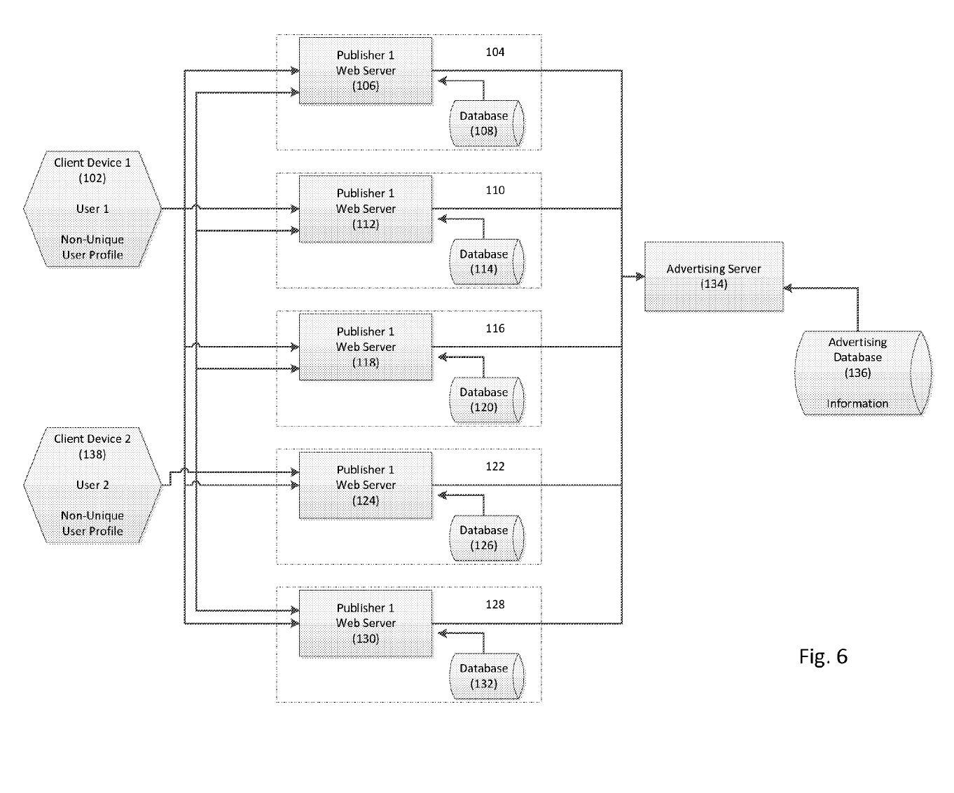

Referring to FIG. 6, there is shown a computer system architecture 100 comprising implementations of the present technology. It is to be expressly understood that arrangement 100 is merely one implementation of the present technology. The description thereof that follows is intended to be only a description of an illustrative example of the present technology. This description is not intended to define the scope or set forth the bounds of the present technology. In some cases, what are believed to be helpful examples of modifications to the computer system 100 may also beset forth hereinbelow. This is done merely as an aid to understanding, and, again, not to define the scope or set forth the bounds of the present technology. These modifications are not exhaustive list, and, as a person skilled in the art would understand, other modifications are likely possible. Further, it should not be interpreted that where this has not been done, i.e. where no examples of modifications have been set forth, that no modifications are possible and/or that what is described is the sole manner of implementing that element of the present. As a person skilled in the art would understand, this is likely not the case. In addition it is to be understood that computer system architecture 100 provides a very simple implementation of the present technology, which is presented in this manner as an aid to understanding. As persons skilled in the art would understand, most implementations of the present technology would be of a much greater complexity.

Computer system architecture 100 includes two client devices 102, 138. In the present implementation, client devices are each an Apple™ iPhone™ 4S™ smartphone. In other implementations client devices may include other makes and/or models of smartphone, tablet computer, e-reader, laptop computer, desktop computer, or another Internet-enabled device. Client devices 102, 138 are in communication with the Internet (which may, depending on a particular circumstances be via mobile telephony network, a WiFi network, or a Bluetooth™ connection. Client devices 102, 138 have installed thereon a web browser application Safari™; other web browsers and/or other Internet-enabled applications may also be installed thereon.

Computer system architecture 100 includes a first Internet resource 104. In this implementation first Internet resource 104 is a first publisher website that is published on the Internet by a first Internet publisher via a first publisher web server 106. The first publisher web server 106 includes appropriate hardware and software to enable the serving of the first publisher website (including a first publisher database 108). In this implementation, for ease in understanding, as a non-limiting example, the first publisher website provides information on the X-Games™ sporting event, and no other types of information. Thus, in this implementation, as a non-limiting example, first Internet resource 104 is associated with the following categories: “male”, “age 18-35”, and “sports”, which are stored in the advertising database 136 (which described in further detail below). In this implementation, these categories were manually (i.e. by a human being) assigned to the first Internet resource 104 after investigation into the content being provided by the first Internet resource 104.

Computer system architecture 100 also includes a second Internet resource 110. In this implementation second Internet resource 110 is a second publisher website that is published on the Internet by a second Internet publisher via a second publisher web server 112. The second publisher web server 112 includes appropriate hardware and software to enable the serving of the second publisher website (including a second publisher database 114). In this implementation, for ease in understanding, as a non-limiting example, the second publisher website provides information on United States professional sporting event scores (such as those of the NFL™, MLB™, NBA™, NHL™, etc.), and no other types of information. Thus, in this implementation, as a non-limiting example, second Internet resource 110 is associated with the following categories: “male” and “sports”, which are stored in advertising database 136. In this implementation, these categories were manually assigned to the second Internet resource 110 after investigation into the content being provided by the second Internet resource 110.

Computer system architecture 100 also includes a third Internet resource 116. In this implementation third Internet resource 116 is a third publisher website that is published on the Internet by a third Internet publisher via a third publisher web server 118. The third publisher web server 118 includes appropriate hardware and software to enable the serving of the third publisher website (including third publisher database 120). In this implementation, for ease in understanding, as a non-limiting example, the third publisher website provides information on men and boy's clothing (such as that available from major U.S. relators such as Gap™, Old Navy™, and Banana Republic™), and no other types of information. Thus, in this implementation, as a non-limiting example, third Internet resource 116 is associated with the following categories: “male” and “fashion”, which are stored in the advertising database 136. In this implementation, these categories were manually assigned to the third Internet resource 116 after investigation into the content being provided by the third Internet resource 116.

Computer system architecture 100 also includes a fourth Internet resource 122. In this implementation fourth Internet resource 122 is a fourth publisher website that is published on the Internet by a fourth Internet publisher via a fourth publisher web server 124. The fourth publisher web server 124 includes appropriate hardware and software to enable the serving of the fourth publisher website (including fourth publisher database 126). In this implementation, for ease in understanding, as a non limiting-example, the fourth publisher website provides information from Men's Health™ magazine, and no other types of information. Thus, in this implementation, as a non-limiting example, fourth Internet resource 122 is associated with the following categories: “male”, “news” and “interested in health”, which are stored in the advertising database 136. In this implementation, these categories were manually assigned to the fourth Internet resource 122 after investigation into the content being provided by the fourth Internet resource 122.

Computer system architecture 100 also include a fifth Internet resource 128. In this implementation fifth Internet resource 128 is a fifth publisher website that is published on the Internet by a fifth publisher via a fifth publisher webserver 130. The fifth publisher web server 130 includes appropriate hardware and software to enable the serving of the fifth publisher website (including fifth publisher database 132). In this implementation, as a non-limiting example, the fifth publisher website is an Internet search engine. Thus, in this implementation, as a non-limiting example, no categories associated with the fifth Internet resource 128 are stored in the advertising database 136. In this implementation, the lack of categories being assigned to the fifth Internet resource 128 was automatically determined via a computerized investigation of the fifth Internet resource 128.

Computer system architecture 100 also includes an advertising server 134. The advertising server is communication via the Internet with the first publisher web server 106, the second publisher web server 112, the third publisher web server 118, the fourth publisher web server 124, and the fifth publisher web server 130. The advertising server 134 is also in communication with the advertising database 136. The advertising server 134 includes appropriate hardware and software to carry out the tasks ascribed to it that are detailed hereinbelow. The advertising database 136 is, in this implementation, a conventional relational database. In this implementation, stored in the advertising database are: (1) information related to the categorization of Internet resources; (2) information related to the various groups of users including the classifications thereof; and (3) advertising information (content) to be served to users. (In this implementation, as an over-simplification for ease in understanding, all of the information is stored in a single database, the advertising database.)

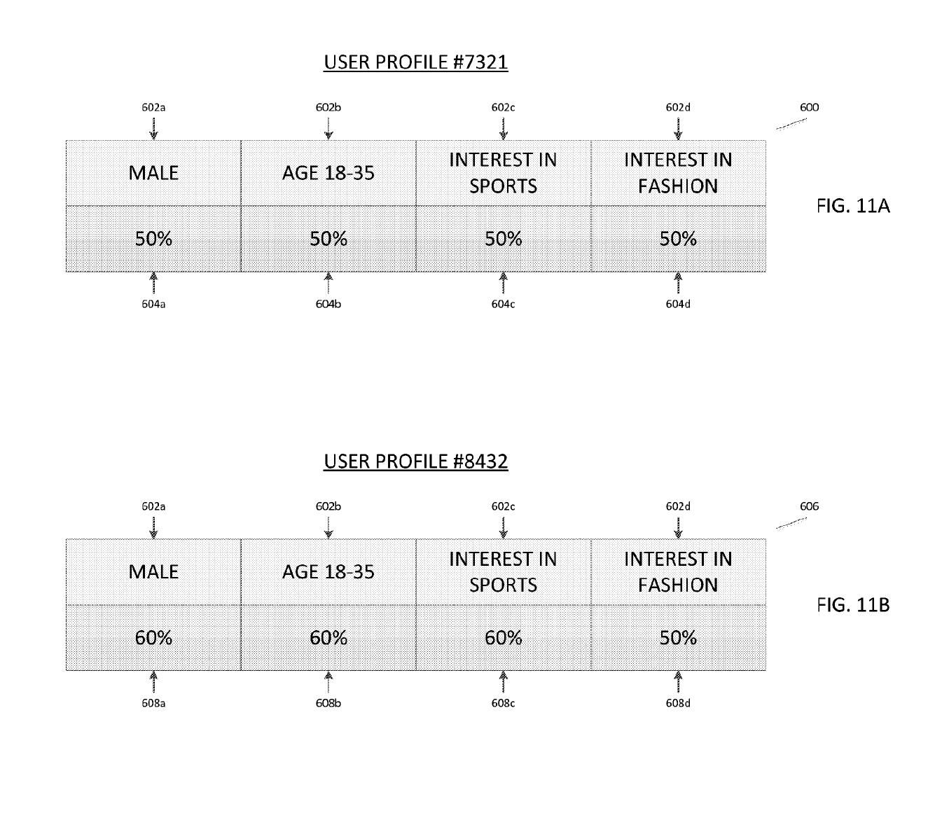

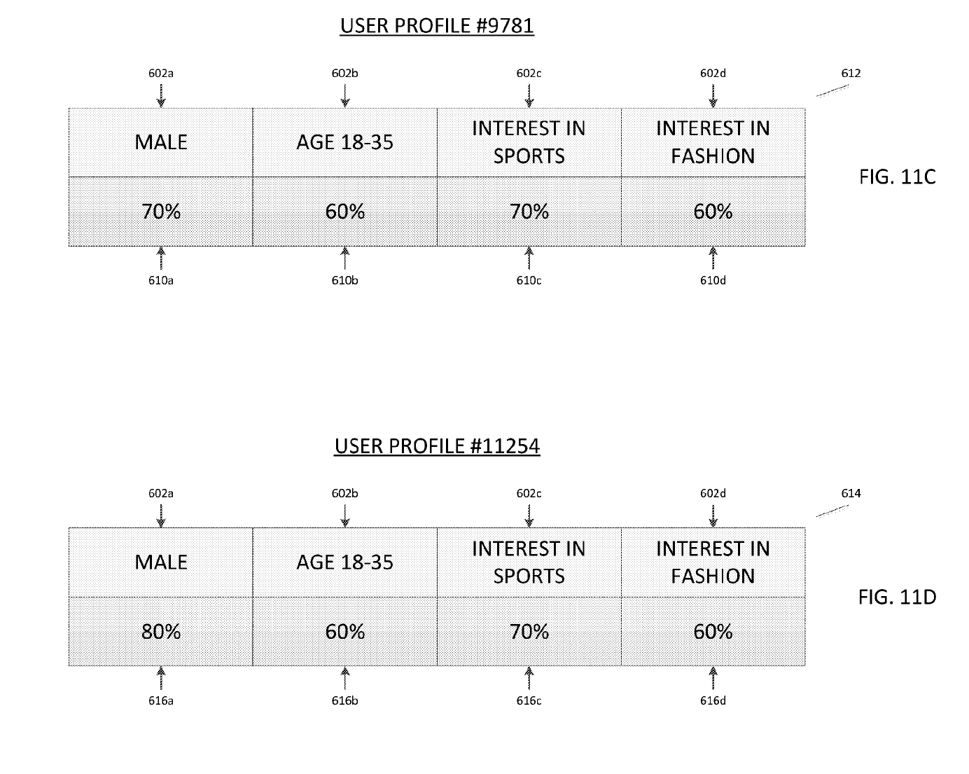

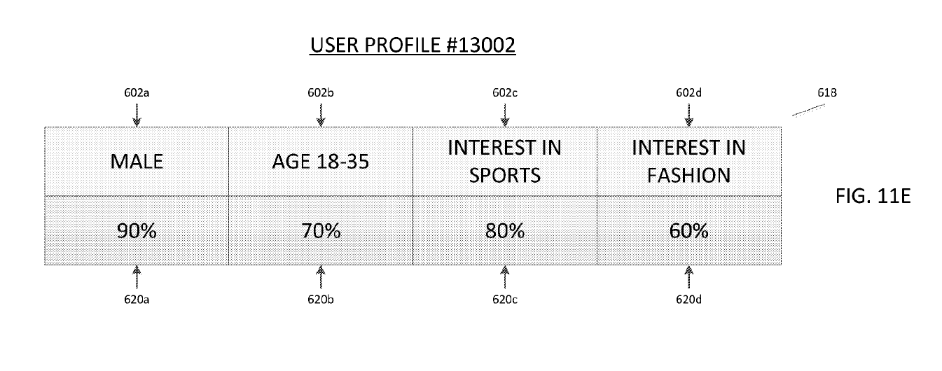

Referring to FIG. 11A, in this example, for purposes of illustration and ease of explanation, a very simplistic classification structure for user profiles (a one user profile 600 being shown in FIG. 11A) is employed. The classifications used are male (classification 602a), age 18-35 (classification 602b), interest in sports (classification 602c), interest in fashion (classification 602d). Further a percentage (604a, 604b, 604c, 604d) is associated with each classification (602a, 602b, 602c, 602d—respcetively) indicating the probability with respect to that classification. In this example, the probabilities are limited to being a multiple of ten, thus one of 0%, 10%, 20%, . . . to 100%. Therefore for each classification 602 there can be one of eleven possible probabilities 604. There are thus 11⁴ or 14,641 total possible combinations of probabilities 604 for each of the four classifications 602. As any particular individual user profile could have any of these possible combinations of probabilities 604 with respect to the four classifications 602, there is a total of 14,641 possible user profiles. As each user profile 600 is associated with its own group of users, there is a total of 14,461 possible groups of users (each having their own specific classification). As was discussed above, each user is a member of one of the groups with respect to the system, and the specific user profile of that group is stored on that user's client device.

In this example, each of those 14,641 possible groups is numbered with a number of between 1 and 14,461. The user profile each group is numbered with the same number as the number of the group. For purposes of illustration, group number 7321 (shown in FIG. 11A and labeled with reference number 600) is the group where the probability of each of the classifications is 50% (i.e. the probability that an individual being a member of that group is a male is 50%, the probability that an individual being a member of that group is between age 18 to 35 is 50%, the probability that an individual being a member of that group is interested in sports is 50%, and the probability that an individual being a member of that group is interested in fashion is 50%).

In this example, for ease of understanding, the initial user profile is #7321 (indicating that the user is a member of group 7321). As is described in further detail below, the initial user profile is the user profile that all users who do not currently have a user profile on their client device (either because one has never existed or any existing one was deleted).

Referring to FIGS. 6 & 10A-10C, for purposes of illustration and explanation, in a non-limiting example, first client device 102 is considered to have never been previously connected to the Internet prior to the following. First client device 102 therefore has no user profile thereon (with respect to the present technology). Nothing is “known” (with respect to the present technology) about the user (i.e. the first user) of the first client device 102. First client device 102 is connected to the Internet via a conventional manner (e.g. a WiFi network). Once connected to the Internet, first client device 102 may receive a request for information from the first Internet resource 104, i.e. the first user desires to be provided with the web site published via first Internet web server 106. While this may occur in a number of conventional manners, first user may, for example, start the Safari web browser application on first client device 102 by taping on the Safari icon on the touch-sensitive screen of the first client device 102 and then may enter the URL of the first Internet resource 104 into the Safari address bar via the first client device's 102 user interface's (e.g, touch screen) virtual keyboard (at 501).

The first client device 102 then sends a request for information to the first publisher web server 106 of the first Internet resource 104 via the Internet (at 502). The request for information would include request to be provided with the homepage of the website of the first Internet resource 104). The first publisher web server 106 of the first Internet resource receives the first client device's 102 request (at 504), and sends back to the first client device 102 a request for a user profile (at 506). In this example, since the first client device 102 does not have any user profile (with respect to the system), when the first client device 102 receives the request for a user profile from the first publisher web server 106 (at 508), no user profile is located (at 510). The first client device 102 thus sends a nil response to the first publisher web server 106 (at 512), which is received by the first publisher web server 106 (at 514).

First publisher web server 106 sends to the nil response with respect a user profile along with a request for advertising and a user profile to advertising server 134 (at 516). First publisher web server 106 also proceeds to receive content (i.e. the first publisher web site) from the first publisher database 108 (at 518). First publisher web server 106 sends the retrieved content to the first client device 102 (at 520), which is received by the client device 102 (at 522).

Advertising server 134 receives the nil response with respect to the user profile, the request for advertising, and the request for a user profile from first publisher web server 106 (at 524). Advertising server 134 (being aware of that the source of the requests is first publisher web server 106) retrieves the categories related to the first publisher content from the advertising database 136 (at 526) and categorizes that content (at 528) (which in the present simplistic example is basically achieved by having retrieved the categories from the advertising database 136). Advertising server retrieves the initial user profile (600—in FIG. 11A) from the advertising database 136 (at 530) and updates the classifications of the initial user profile (600) in view of the categorization of the first publisher content (at 532). Advertising server 134 then locates (and retrieves from the advertising database 136) an updated user profile (606 in FIG. 11B) corresponding to the updated classifications (at 534).

Using the details from the present example to illustrate this process, as is shown in FIG. 11A, in the initial user profile 600 (#7321), each of the classifications 602a, 602b, 602c, 602d has a probability 604a, 604b, 604c, 604d (respectively). As was described above, first Internet resource 104 (and thus its content) is categorized as “male”, “age 18-35” and “sports”. Thus (in this example), taking into account the categorization of the first Internet resource 104, the advertising server 134 updates the probabilities 604a, 604b, 604c, 604d of the classifications 602a, 602b, 602c, 602d of the then current user profile (which in this example is the initial user profile 600 (#7321)) to be as follows: male: 60% probability, age 18-35: 60% probability, interested in sports 60% probability, and interested in fashion 50% probability. (In this example the probability of each classification corresponding to a categorization of the first Internet resource 104 was increased to its next level. Once again, it should be understood that the present example has been constructed in an overly simplistic fashion for ease in understanding.) The advertising server 134 then determines that the user profile (606 in FIG. 11B) having that updated classification/probability combination is #8432.

Once the advertising server 134 has determined the updated user profile 606, it sends the updated user profile 606 (in this example all that is sent is the number of the user profile—i.e. #8432 and the number of the initial user profile—#7321 (for historical purposes) and advertising content related to the updated user profile 606 to the first publisher web server 106 (at 536). The advertising web server 134 determines which advertising content is related to the updated user profile 606 by comparing a classification of each piece of advertising content with the classification of the updated user profile 606. In this example, for ease in understanding, the advertising server 134 only selects advertising content that is classified identically to the user profile in question. Thus only advertising content having been classified as appropriate for individuals having the following profile: male: 60% probability, age 18-35: 60% probability, interested in sports 60% probability, and interested in fashion 50% probability is sent to the first publisher web server 104. (The advertising server 134 also uses other information available to it, such as the then current location of the first client device 102, in selecting which advertising content to be sent.) (It should be understood that in other implementations, there is generally a more complex relationship between the advertising classifications and the user profile classifications—no particular relationship being required in respect of the present technology.)

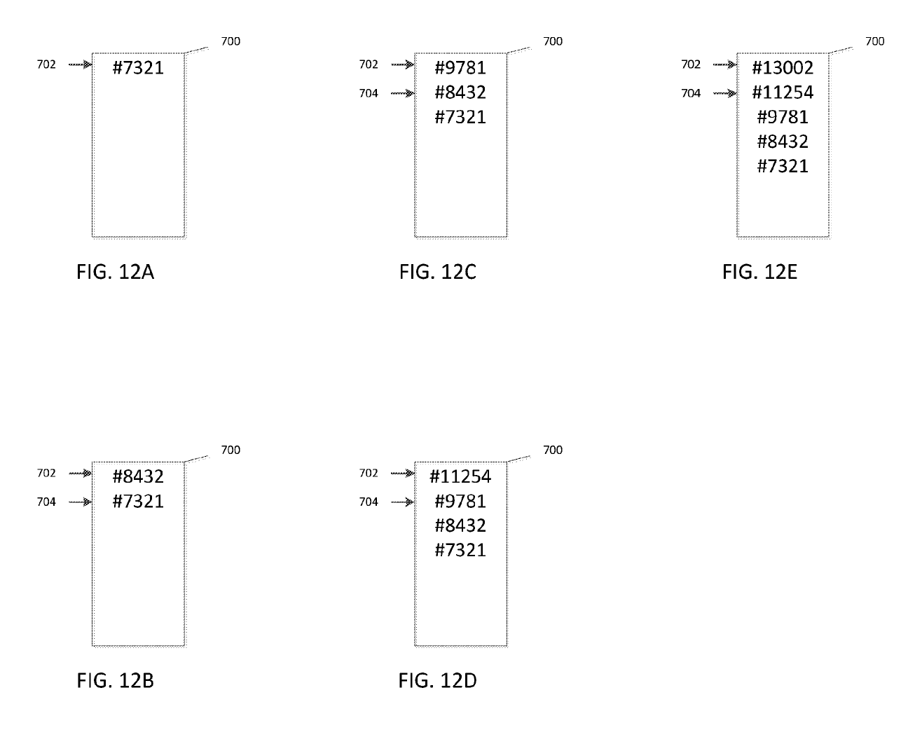

The first publisher web server 106 receives the updated user profile 606 (along with the initial user profile 600) and the advertising content having been sent by the advertising server 135 (at 538), and sends both to the first client device 102 (at 540). The first client device 102 receives the updated user profile 606 (and the initial user profile 600) and the advertising content from the first publisher web server 106 (at 542). The first client device 102 stores the updated user profile 606 in a cookie on the first client device 102 (at 544) and provides the first publisher content (e.g. the first publisher website) and the (particularized) advertising content to the user via the user interface of the first client device 102 (at 546). Thus, at the end of the above procedure, referring to FIG. 12B, the first client device 102 will contain in a cookie 700 the number #8432—being the then current user profile 702 and the number #7321—being the past user profile 704.

While not described in detail herein to avoid duplication, it should be understood that were the second client device 138 to follow exactly the same procedure, the second client device 138 would end up with the same result, i.e. the numbers #8432 (702) and #7321 (704) stored in a cookie 700 on the second client device 138.

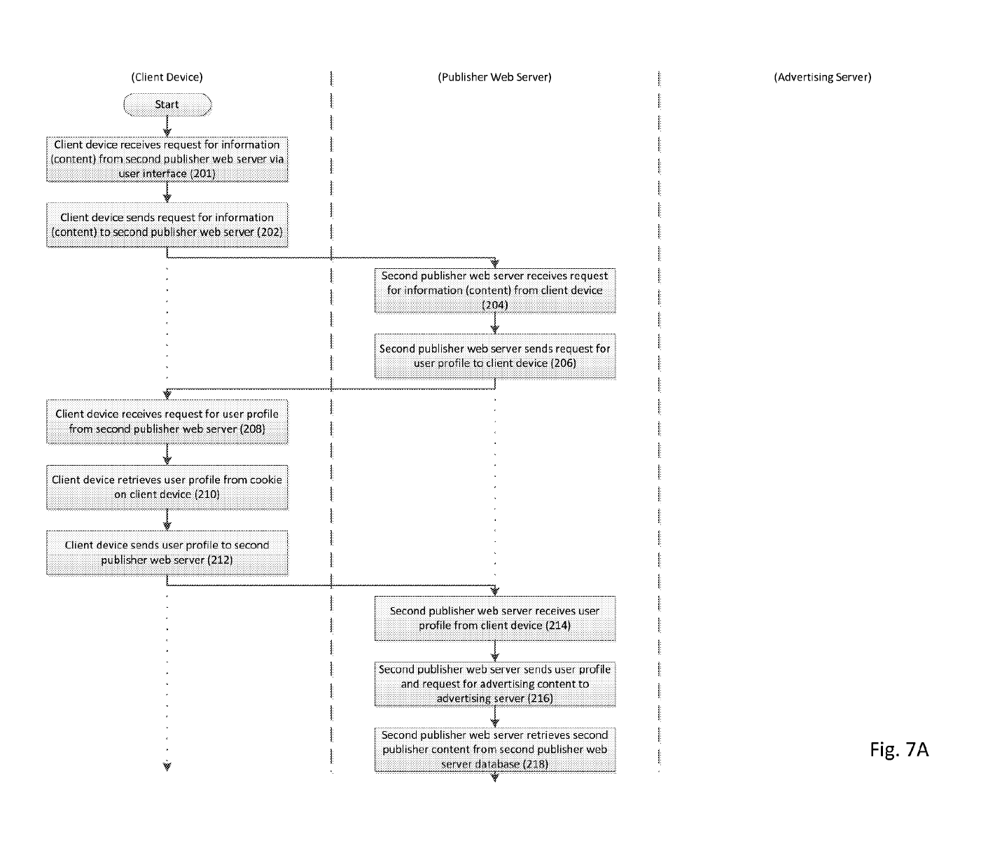

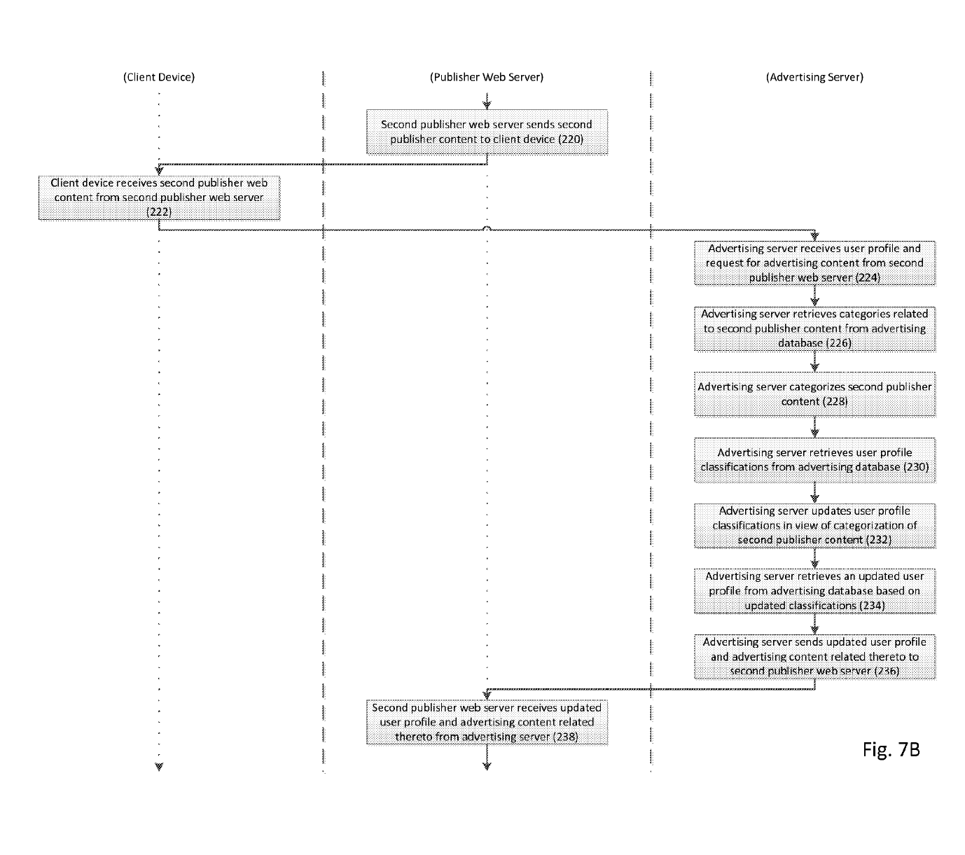

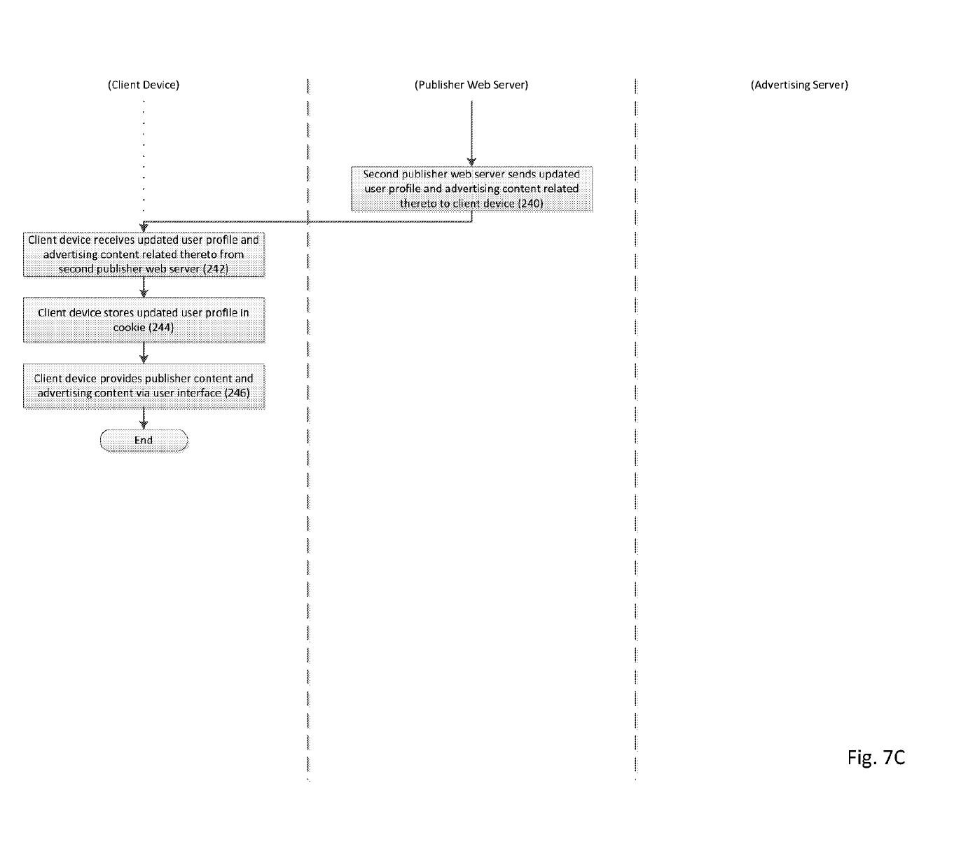

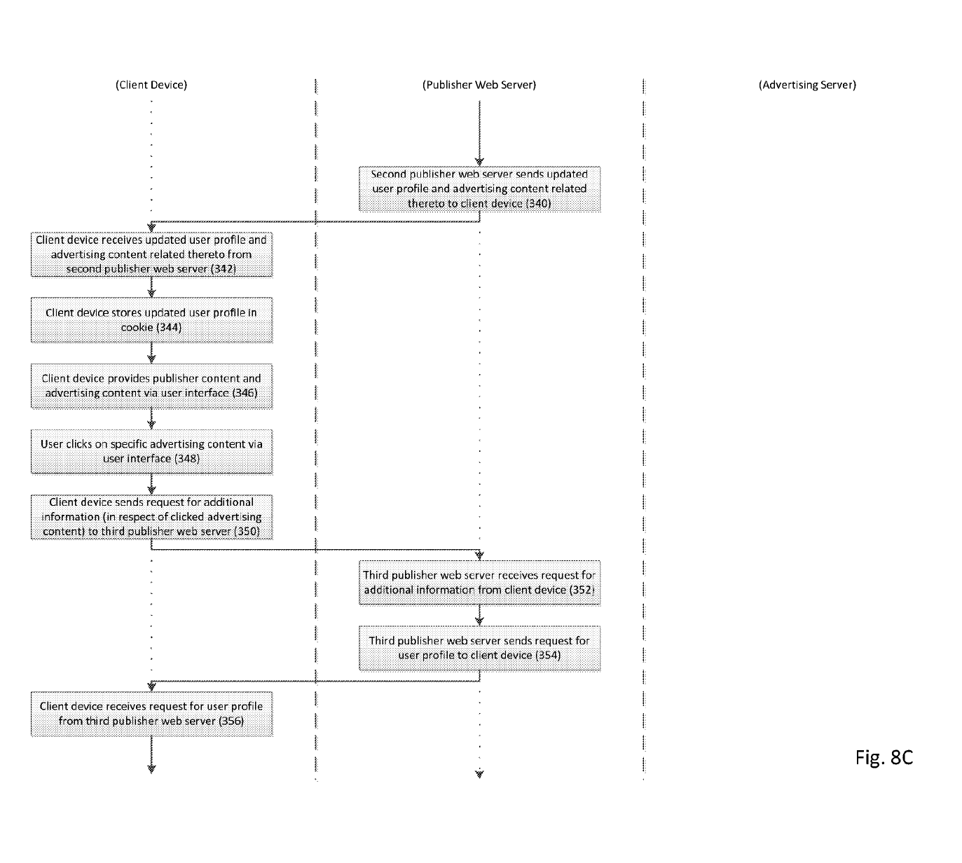

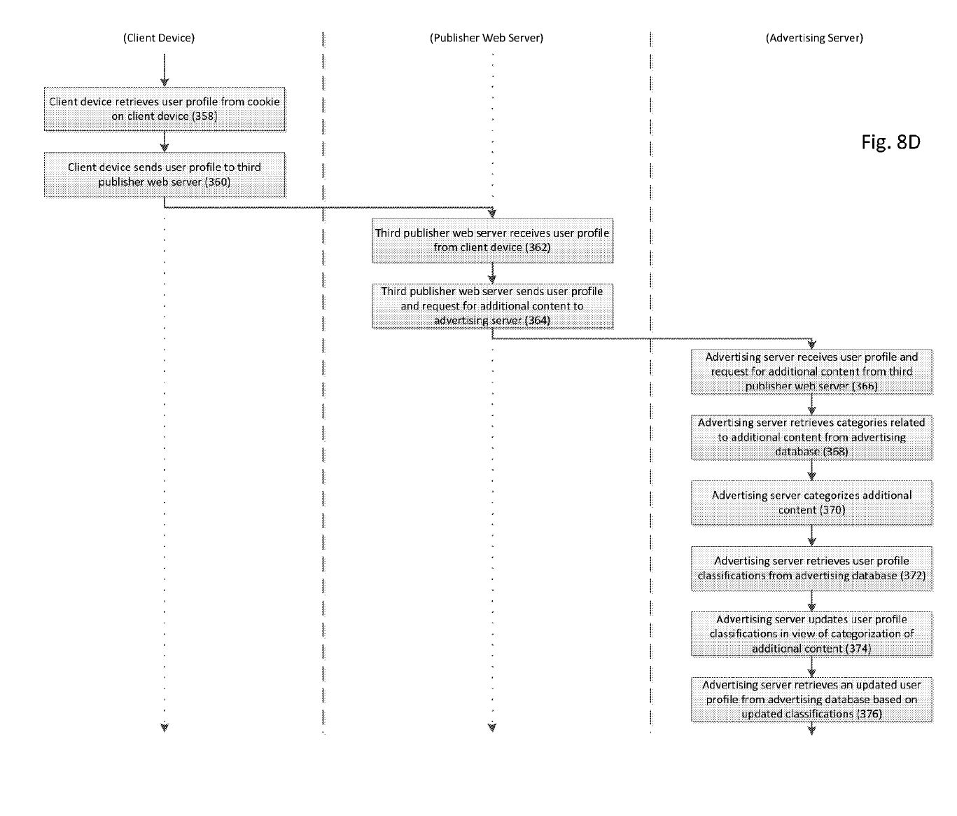

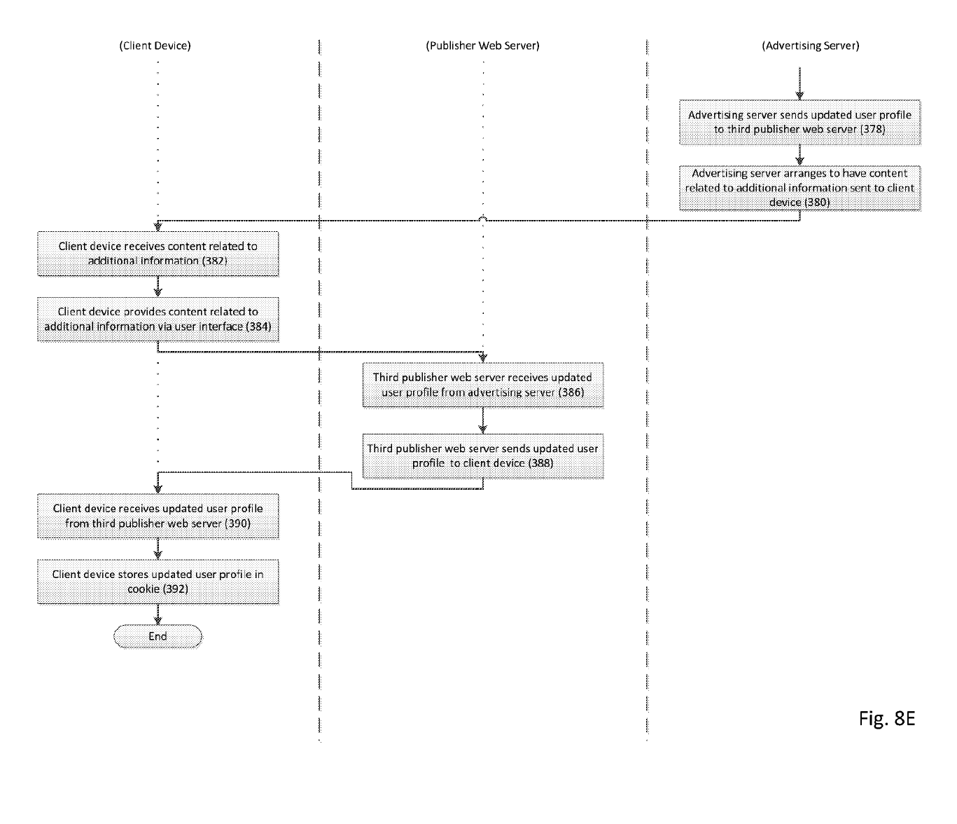

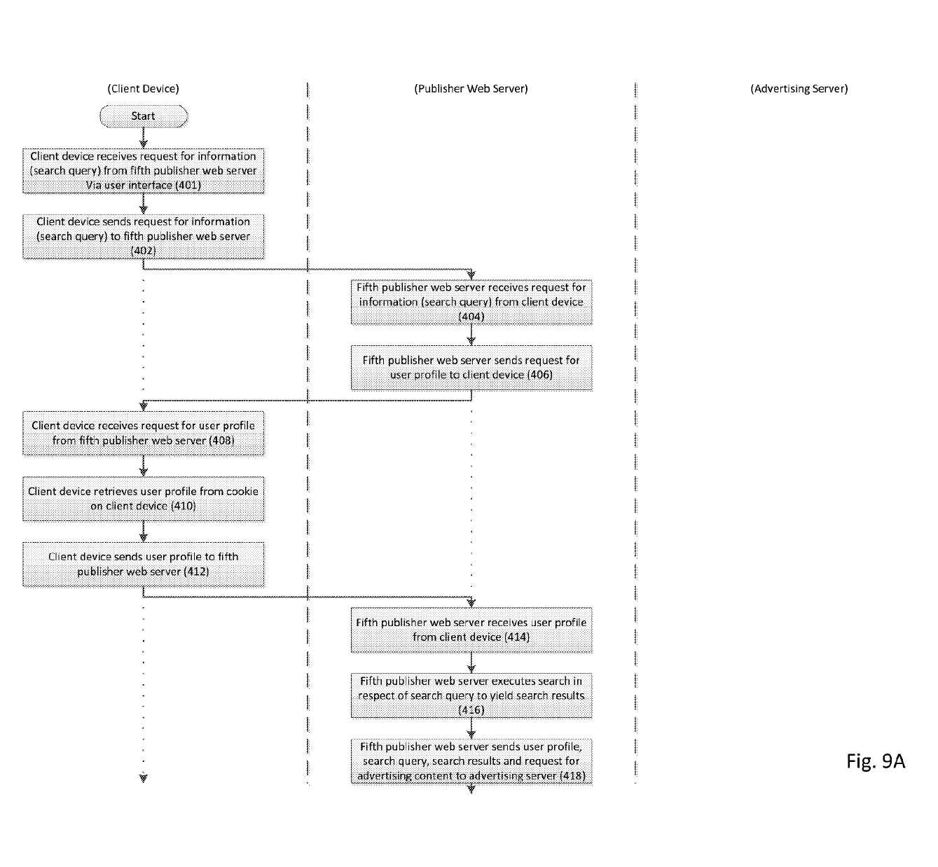

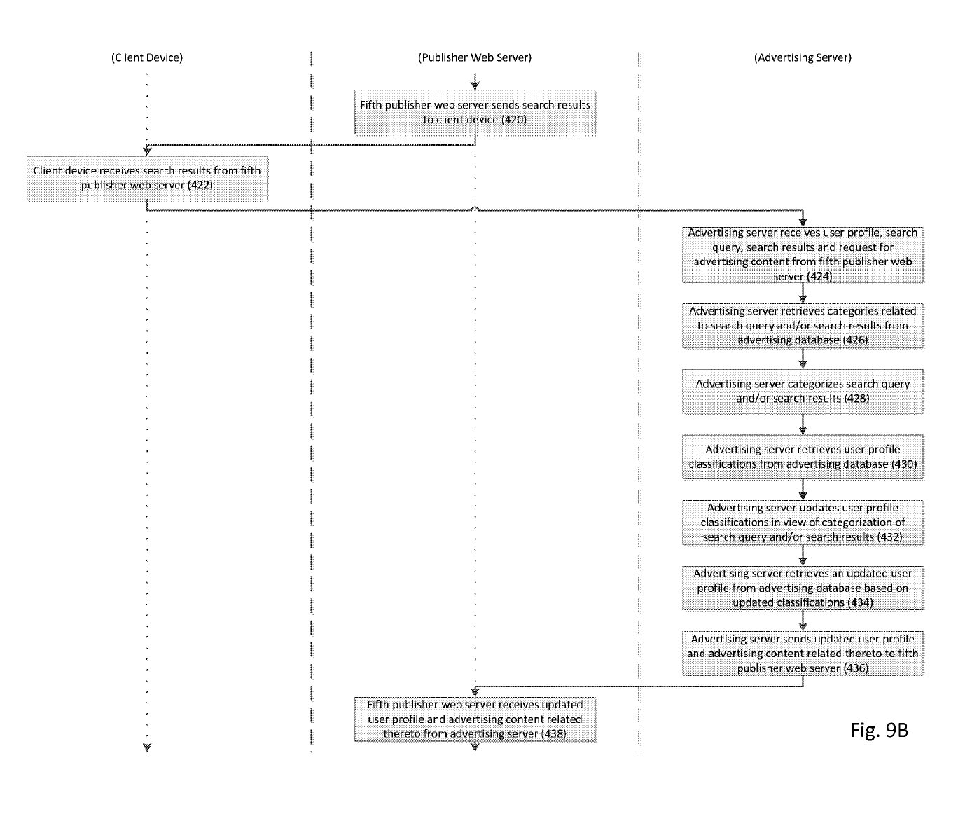

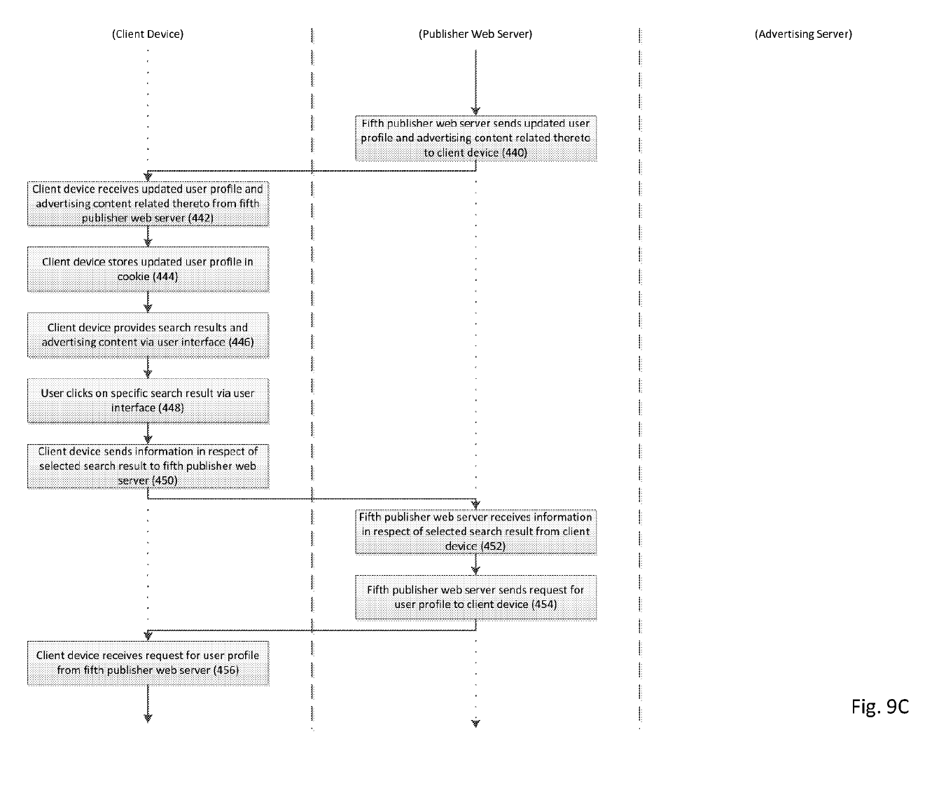

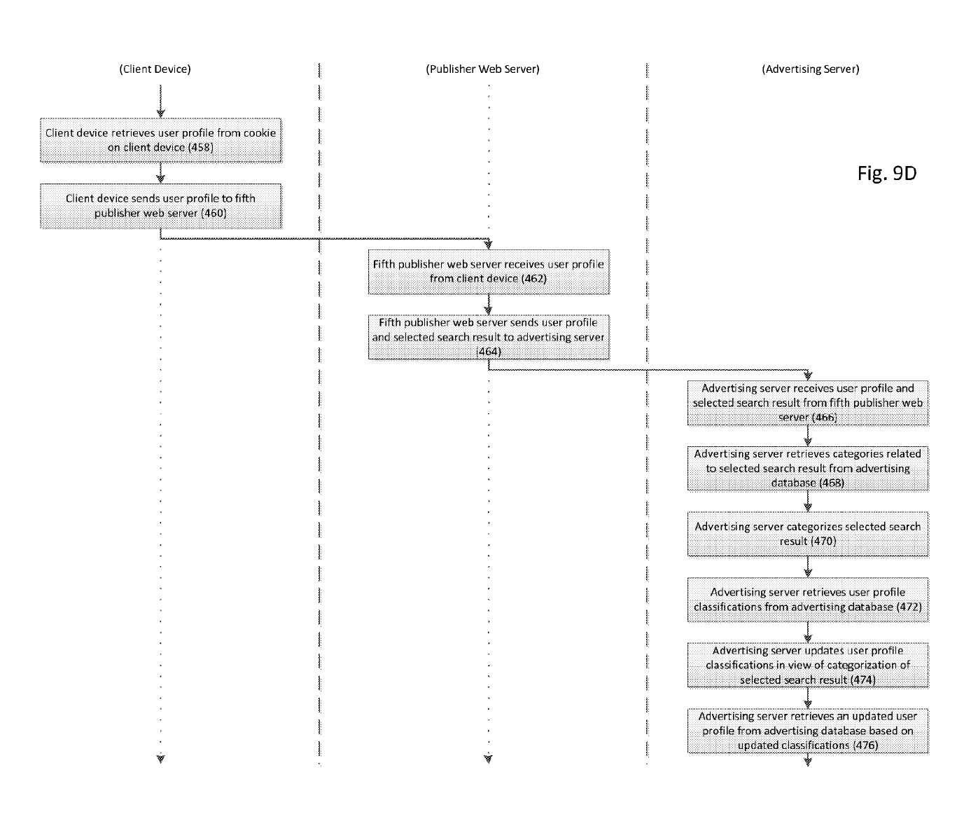

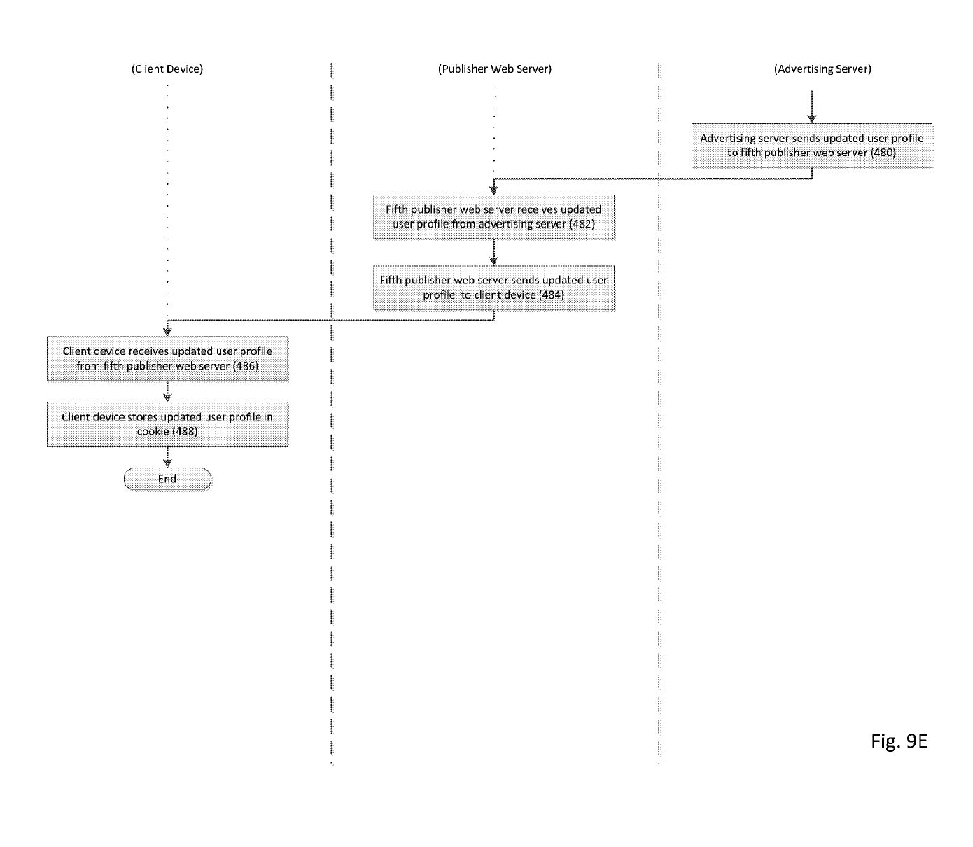

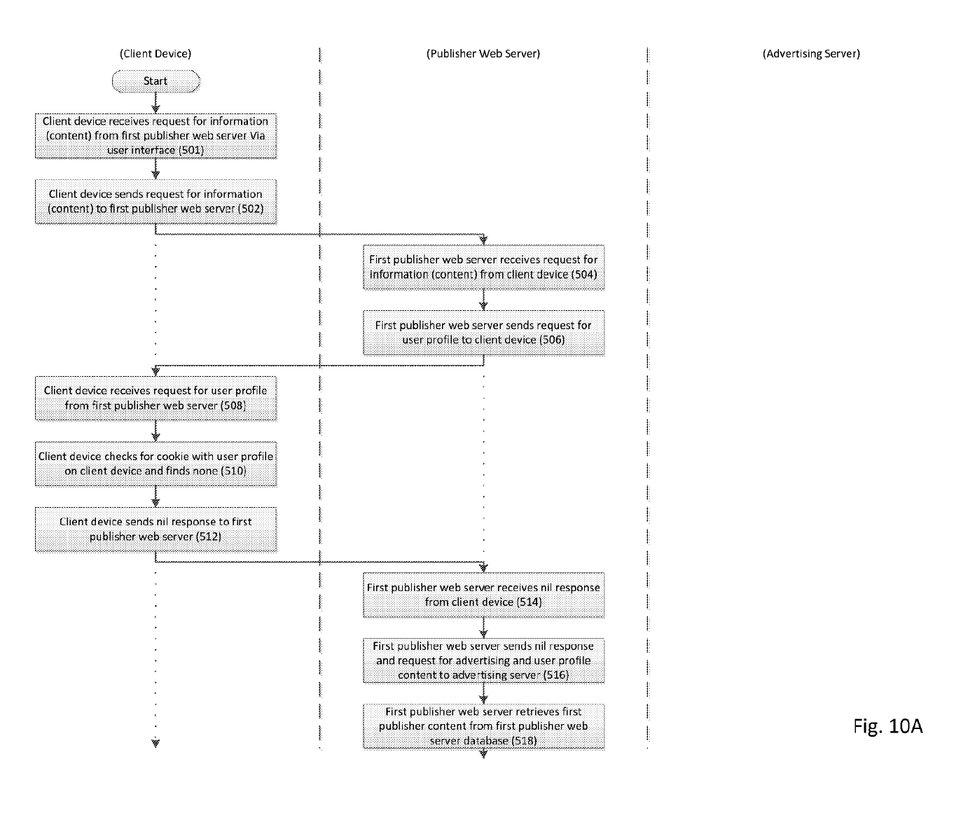

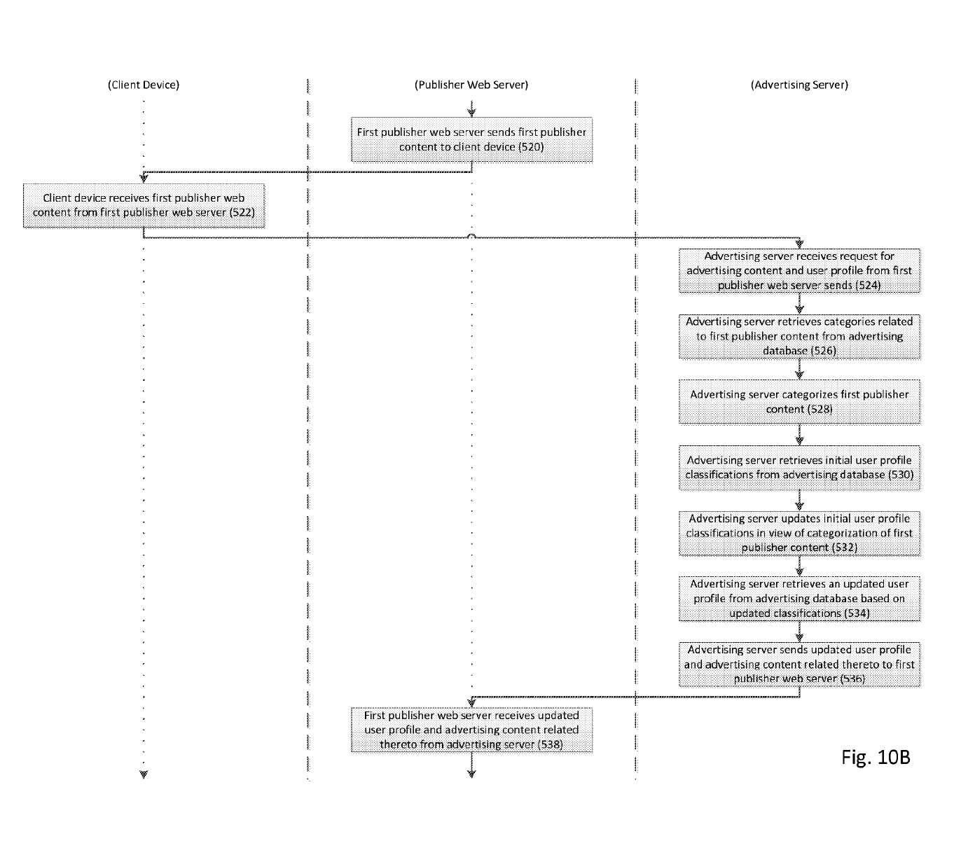

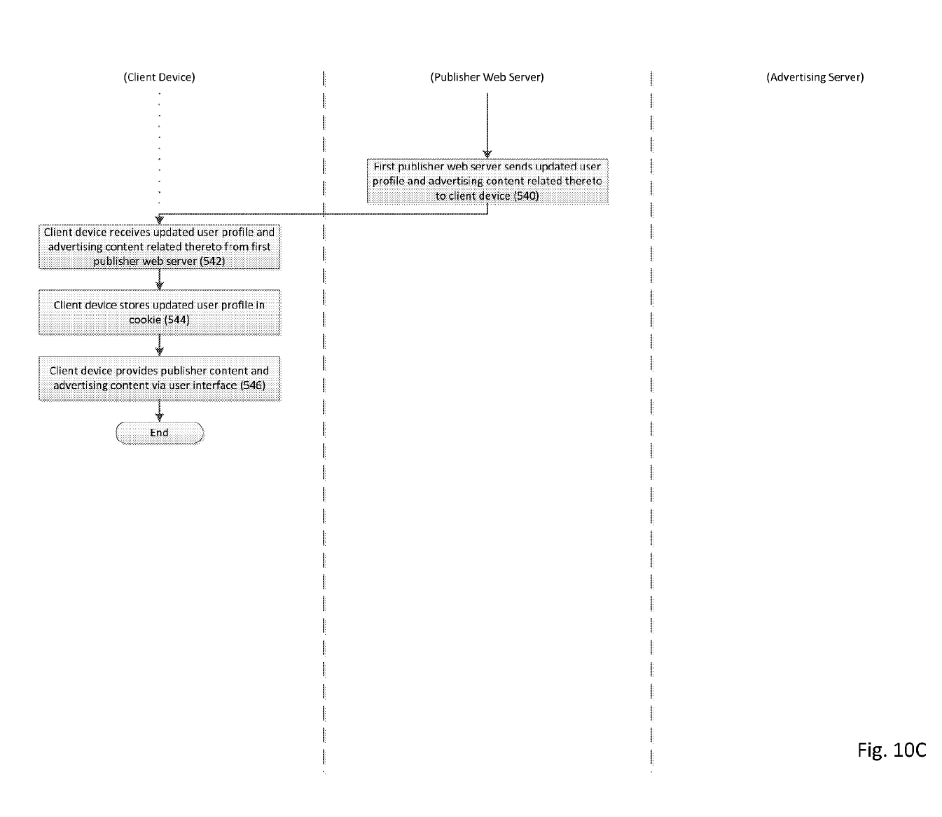

Referring to FIGS. 7A-7C, there shown a procedure of what occurs when the first client device 102 (or the second client device 138—more on this below) requests information from a second Internet resource 110. The procedure starts when the first client device 102 receives a request for information (content—i.e. the a second publisher website of the second Internet resource 110) from the second Internet resource 110 via the user interface of the first client device 102 (at 201). The first client device 102 sends the request to the second publisher web server 112 of the second Internet resource 110. The second publisher web server 112 receives the request for information from the first client device 102 (at 204) and sends to the first client device 102 a request for the user profile stored on the first client device 102 (at 206).

The first client device 102 receives the request for the user profile from the second publisher web server 112 (at 208) and retrieves the then current user profile (606 in FIG. 11B) from a cookie (700 in FIG. 12B) stored on the first client device 102 (at 210). Thus, in the present example, all that is retrieved is the number #8432 (702 in FIG. 12B). The first client device 102 sends the user profile 606 to the second publisher web server 112 (at 212). The second publisher web server 112 receives the user profile 606 from the first client device 102 (at 214) and sends the user profile 606, along with a request for advertising content, to the advertising web server 134 (at 216). The second publisher web server 112 also retrieves the second publisher content (i.e. second publisher web site) from the second publisher database 114 (at 218), and sends the content to the first client device 102 (at 220). The first client device 102 receives the second publisher content (at 222).

The advertising server 134 receives the user profile 606 and the request for advertising content from the second publisher web server (at 224).

Advertising server 134 (being aware of that the source of the request is second publisher web server 112) retrieves the categories related to the second publisher content from the advertising database 136 (at 226) and categorizes that content (at 228) (which in the present simplistic example is basically achieved by having retrieved the categories from the advertising database 136). Advertising server 134 retrieves the classifications of the then current user profile (606) from the advertising database 136 (at 230) and updates the classifications of them current user profile (606) in view of the categorization of the second publisher content (at 232). Advertising server 134 then locates (and retrieves from the advertising database 136) an updated user profile (612 in FIG. 11C) corresponding to the updated classifications (at 234).

Using the details from the present example to illustrate this process, as is shown in FIG. 11B, in the then current user profile 606 (#8432), each of the classifications 602a, 602b, 602c, 602d has a probability 608a, 608b, 608c, 608d (respectively). As was described above, second Internet resource 110 (and thus its content) is categorized as “male”, and “sports”. Thus (in this example), taking into account the categorization of the second Internet resource 110, the advertising server 134 updates the probabilities 610a, 610b, 610c, 610d of the classifications 602a, 602b, 602c, 602d of the then current user profile (which in this example is user profile 606 (#8432—702 in FIG. 12B)) to be as follows: male: 70% probability, age 18-35: 60% probability, interested in sports 70% probability, and interested in fashion 50% probability. (In this example the probability of each classification corresponding to a categorization of the second Internet resource 110 was increased to its next level. Once again, it should be understood that the present example has been constructed in an overly simplistic fashion for ease in understanding.) The advertising server 134 then determines that the user profile (612 in FIG. 11C) having that updated classification/probability combination is #9781.

Once the advertising server 134 has determined the updated user profile 612, it sends the updated user profile 612 (in this example all that is sent is the number of the user profile—i.e. #9871) and advertising content related to the updated user profile 612 to the second publisher web server 112 (at 236). The advertising web server 134 determines which advertising content is related to the updated user profile 612 by comparing a classification of each piece of advertising content with the classification of the updated user profile 612. In this example, for ease in understanding, the advertising server 134 only selects advertising content that is classified identically to the user profile in question. Thus only advertising content having been classified as appropriate for individuals having the following profile: male: 70% probability, age 18-35: 60% probability, interested in sports 70% probability, and interested in fashion 50% probability is sent to the second publisher web server 112. (The advertising server 134 also uses other information available to it, such as the then current location of the first client device 102, in selecting which advertising content to be sent.) (It should be understood that in other implementations, there is generally a more complex relationship between the advertising classifications and the user profile classifications—no particular relationship being required in respect of the present technology.)

The second publisher web server 112 receives the updated user profile 606 (i.e. the number #9871) and the advertising content having been sent by the advertising server 135 (at 538), and sends both to the first client device 102 (at 540). The first client device 102 receives the updated user profile 606 (i.e. the number #9871) and the advertising content from the first publisher web server 106 (at 542). The first client device 102 stores the updated user profile 606 in a cookie 700 (FIG. 12C) on the first client device 102 (at 544) and provides the first publisher content (e.g. the first publisher website) and the (particularized) advertising content to the user via the user interface of the first client device 102 (at 546). Thus at the end of the above procedure, referring to FIG. 12C, the first client device 102, will contain in a cookie 700 the number #9871 (702 in FIG. 12C) as the then current user profile, and the numbers #8432 and #7321 (704 in FIG. 12C) as the past user profiles. Via the above example, it will be obvious that in its interactions with the first client device 102 the advertising server 134 did not receive any unique identifier of the either the user of the first client device 102 or the first client device 102 itself. Thus it could not uniquely identify first client device 102.

While not described in detail herein to avoid duplication, it should be understood that were the second client device 138 to follow exactly the same procedure, the second client device 138 would end up with the same result, i.e. the number #9871 stored in a cookie on the second client device 138 as the then current user profile. Thus it can be seen that the advertising server could not uniquely identify second client device 138 either. The interactions of the advertising server 134 are the same with respect to both the first client device 102 and the second client device 134 (in this example) because they are both members of the same group of users. Neither device 102, 134 can be uniquely identified by the advertising server 138.

(For ease of illustration, the classifications are the same as the categories of the Internet resources in this implementation.)

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1-3. (canceled)

4. A method of providing a client device with particularized information in respect of a group of persons to which a user of the client device belongs, without employing a unique identifier with respect to the user or the client device, the method comprising:
sending by the client device to at least one server via a communications network a request for first information from at least one network resource;
sending by the client device to the at least one server via the communications network a user profile in respect of the user of the client device, the user profile including no unique user identification with respect to the user or the client device;
receiving by the client device from the at least one server via the communications network the first information; and
receiving by the client device from the at least one server via the communications network second information particularized in respect of the group of persons to which the user of the client device belongs, the second information being based at least in part on the profile.

5. The method of claim 4, further comprising receiving by the client device from the at least one server via the communications network an updated user profile, the updated user profile taking into account a category of the first information.

6. The method of claim 4, further comprising:
categorizing the first information by the client device; and
updating the user profile by the client device to take into account the categorized first information to create an updated user profile.

7. The method of claim 5, further comprising receiving by the client device from the at least one server via the communications network a collection of categories to be used in categorization of the first information.

8. The method of claim 4, further comprising sending by the client device to the at least one server via the communications network additional information respecting actions of the user with respect to at least one of the at least one network resource and an additional network resource, the additional information including no unique identifier with respect to the user or the client device; and wherein the second information is based at least in part on the additional information.

9. The method of claim 4, further comprising deleting the user profile from the client device thereby preventing receipt of the second information particularized in respect of the group of persons to which the user of the client device belongs until a new user profile is created.

10. The method of claim 4, wherein the request for first information is a request to effect a search in respect of a search query and to be provided with results of the search.

11. The method of claim 4, wherein the request for first information is a request to navigate to an Internet website.

12. The method of claim 4, wherein the request for first information is a request to be provided with further information in respect of an advertisement having been provided to the user via a user interface of the client device.

13. The method of claim 4, wherein the user profile includes a series of categories.

14. The method of claim 13, wherein the categories are based on estimated interests of the user.

15. The method of claim 14, wherein the estimated interests of the user are based at least in part on a past usage history of the user.

16. The method of claim 13, wherein the categories are based in part on an estimated demographic of the user.

17. The method of claim 16, wherein the estimated demographic of the user is based at least in part of a past usage history of the user.

18. The method of claim 13, wherein the user profile includes probabilities associated with the categories.

19. The method of claim 4, wherein the user profile is encoded.

20. The method of claim 4, wherein the user profile is stored in a cookie on the client device.

21. The method of claim 4, wherein the user profile is stored in a library on the client device.

22. The method of claim 4, wherein the second information is advertising information.

23-25. (canceled)

26. A computer system for providing a client device with particularized information in respect of a group of persons to which a user of the client device belongs, without employing a unique identifier with respect to the user or the client device, the system comprising:
a request for first information dispatch component that effects dispatch by the client device to at least one server via a communications network of a request for first information from at least one network resource;
a user profile dispatch component that effects dispatch by the client device to the at least one server via the communications network of a user profile in respect of the user of the client device, the user profile including no unique identifier with respect to the user or the client device;
a first information reception component that effects reception by the client device from the at least one server via the communications network of the first information; and
a second information reception component that effects reception by the client device from the at least one server via the communications network of second information particularized in respect of the group of persons to which the user of the client device belongs, the second information being based at least in part on the user profile.

27-66. (canceled)
